(19) United States
(12) Patent Application Publication
(10) Pub. No.: US 2024/0284279 A1
(43) Pub. Date: Aug. 22, 2024

(54) METHOD, USER EQUIPMENT, AND BASE STATION FOR MANAGING L1/L2 TRIGGERED MOBILITY

(71) Applicant: FG Innovation Company Limited, Tuen Mun (HK)

(72) Inventors: WAN-CHEN LIN, Taipei (TW); MEI-JU SHIH, Taipei (TW); CHIA-HUNG LIN, Taipei (TW); CHIA-HSIN LAI, Taipei (TW)

(21) Appl. No.: 18/444,603

(22) Filed: Feb. 16, 2024

Related U.S. Application Data
(60) Provisional application No. 63/446,641, filed on Feb. 17, 2023.

(51) Int. Cl. H04W 36/00; H04W 24/10; H04W 28/02; H04W 48/08

(52) U.S. Cl. CPC H04W 36/008355; H04W 24/10; H04W 28/0215; H04W 48/08

(57) ABSTRACT

A method for managing LTM performed by a UE is provided. The method includes transmitting at least one of a first UE capability information message and a second UE capability information message, the first UE capability information message indicating that the UE is capable of intra-frequency-based measurement and generating intra-frequency-based measurement report, and the second UE capability information message indicating that the UE is capable of inter-frequency-based measurement and generating inter-frequency-based measurement report; receiving first RRC signaling and second RRC signaling, the second RRC signaling being used for the LTM and configuring first configurations; transmitting, a measurement report including at least one of the intra-frequency-based measurement report and the inter-frequency-based measurement report; receiving a MAC CE for a cell switching, the MAC CE including an index of one of the first configurations; and performing, based on the index, the cell switching from a first cell to a second cell.

### CROSS-REFERENCE TO RELATED APPLICATION(S)

The present disclosure claims the benefit of and priority to U.S. Provisional Patent Application Ser. No. 63/446,641, filed on Feb. 17, 2023, entitled “METHOD AND APPARATUS FOR MEASUREMENT HANDLING FOR LTM,” the content of which is hereby incorporated herein fully by reference into the present disclosure for all purposes.

### FIELD

The present disclosure is related to wireless communication and, more specifically, to a method, a user equipment (UE), and a base station (BS) for managing layer 1 (L1)/layer 2 (L2)-triggered mobility (LTM) in cellular wireless communication networks.

### BACKGROUND

Various efforts have been made to improve different aspects of wireless communication for cellular wireless communication systems, such as 5th Generation (5G) New Radio (NR), by improving data rate, latency, reliability, and mobility. The 5G NR system is designed to provide flexibility and configurability to optimize network services and types, accommodating various use cases, such as enhanced Mobile Broadband (eMBB), massive Machine-Type Communication (mMTC), and Ultra-Reliable and Low-Latency Communication (URLLC). However, as the demand for radio access continues to grow, there is a need for further improvements in wireless communication in the next-generation wireless communication systems.

### SUMMARY

The present disclosure is related to a method, a user equipment (UE), and a base station (BS) for managing layer 1 (L1)/layer 2 (L2)-triggered mobility (LTM) in cellular wireless communication networks.

In a first aspect of the present application, a method for managing LTM performed by a UE is provided. The method includes transmitting, to a first cell, at least one of a first UE capability information message and a second UE capability information message, the first UE capability information message indicating that the UE is capable of intra-frequency-based measurement and generating an intra-frequency-based measurement report, and the second UE capability information message indicating that the UE is capable of inter-frequency-based measurement and generating an inter-frequency-based measurement report; receiving, from the first cell, first radio resource control (RRC) signaling and second RRC signaling, the second RRC signaling being used for the LTM and configuring multiple first configurations and multiple reference signals for at least one of the intra-frequency-based measurement and the inter-frequency-based measurement, the second RRC signaling being transmitted by the first cell based on the at least one of the first UE capability information message and the second UE capability information message; generating, based on the second RRC signaling, a measurement report including at least one of the intra-frequency-based measurement report and the inter-frequency-based measurement report; transmitting, to the first cell, the measurement report; receiving, from the first cell, a medium access control (MAC) control element (CE) for a cell switching, the MAC CE including an index of one of the multiple first configurations; and performing, based on the index, the cell switching from the first cell to a second cell.

In an implementation of the first aspect, the second RRC signaling includes an RRC reconfiguration message.

In another implementation of the first aspect, the multiple reference signals includes synchronization signal blocks (SSBs) or channel state Information (CSI)-reference signals (RSS).

In another implementation of the first aspect, each of the multiple first configurations is associated with a physical cell identity (PCI) index, and the index includes a PCI index of the second cell.

In another implementation of the first aspect, the first RRC signaling is used for configuring multiple second configurations and the multiple reference signals for the first cell.

In another implementation of the first aspect, the intra-frequency-based measurement report includes a measurement result of the intra-frequency-based measurement, and the inter-frequency-based measurement report includes a measurement result of the inter-frequency-based measurement.

In another implementation of the first aspect, the method further includes in a case that both the first UE capability information message and the second UE capability information message are transmitted, transmitting, to the first cell, a third UE capability information message and an indicator. The third UE capability information message indicates that the UE is capable of generating both the intra-frequency-based measurement report and the inter-frequency-based measurement report in a single measurement report instance, the measurement report includes both a measurement result of the intra-frequency-based measurement and a measurement result of the inter-frequency-based measurement, and the indicator indicates that a first part of the measurement report corresponds to the intra-frequency-based measurement report and a second part of the measurement report corresponds to the inter-frequency-based measurement report.

In another implementation of the first aspect, the first cell is associated with a first base station, and the second cell is associated with a second base station.

In another implementation of the first aspect, the first cell and the second cell are associated with a same base station.

In a second aspect of the present application, a UE for managing LTM is provided. The UE includes one or more processors; and at least one memory coupled to the one or more processors, the at least one memory storing computer-executable instructions that, when executed by the one or more processors, cause the UE to transmit, to a first cell, at least one of a first UE capability information message and a second UE capability information message, the first UE capability information message indicating that the UE is capable of intra-frequency-based measurement and generating an intra-frequency-based measurement report, and the second UE capability information message indicating that the UE is capable of inter-frequency-based measurement and generating an inter-frequency-based measurement report; receive, from the first cell, first radio resource control (RRC) signaling and second RRC signaling, the second RRC signaling being used for the LTM and configuring multiple first configurations and multiple reference signals for at least one of the intra-frequency-based measurement and the inter-frequency-based measurement, the second RRC signaling being transmitted by the first cell based on the at least one of the first UE capability information message and the second UE capability information message; generate, based on the second RRC signaling, a measurement report including at least one of the intra-frequency-based measurement report and the inter-frequency-based measurement report; transmit, to the first cell, the measurement report; receive, from the first cell, a medium access control (MAC) control element (CE) for a cell switching, the MAC CE including an index of one of the multiple first configurations; and perform, based on the index, the cell switching from the first cell to a second cell.

In a third aspect of the present application, a BS for managing LTM is provided. The BS includes one or more processors; and at least one memory coupled to the one or more processors, the at least one memory storing computer-executable instructions that, when executed by the one or more processors, cause the BS to receive, from a user equipment (UE), at least one of a first UE capability information message and a second UE capability information message, the first UE capability information message indicating that the UE is capable of intra-frequency-based measurement and generating an intra-frequency-based measurement report, and the second UE capability information message indicating that the UE is capable of inter-frequency-based measurement and generating an inter-frequency-based measurement report; transmit, to the UE, first radio resource control (RRC) signaling and second RRC signaling, the second RRC signaling being used for the LTM and configuring multiple first configurations and multiple reference signals for at least one of the intra-frequency-based measurement and the inter-frequency-based measurement, the second RRC signaling being transmitted based on the at least one of the first UE capability information message and the second UE capability information message; receive, from the UE, a measurement report including at least one of the intra-frequency-based measurement report and the inter-frequency-based measurement report; transmit, to the UE, a medium access control (MAC) control element (CE) for a cell switching, the MAC CE including an index of one of the multiple first configurations; and perform, based on the index, the cell switching for the UE from a first cell to a second cell.

### BRIEF DESCRIPTION OF THE DRAWINGS

Aspects of the present disclosure are best understood from the following detailed disclosure when read with the accompanying drawings. Various features are not drawn to scale. Dimensions of various features may be arbitrarily increased or reduced for clarity of discussion.

FIG. 1 is a flowchart illustrating a method for managing LTM performed by a UE, according to an example implementation of the present disclosure.

FIG. 2 is a flowchart illustrating a method for managing LTM performed by a BS, according to an example implementation of the present disclosure.

FIG. 3 is a block diagram illustrating a node for wireless communication, according to an example implementation of the present disclosure.

### DESCRIPTION

Some of the abbreviations used in this disclosure include:

| Abbreviation | Full name |
|---|---|
| 3GPP | 3^{rd} Generation Partnership Project |
| 5G | 5^{th} Generation |
| ACK | Acknowledgment |
| AL | Aggregation level |
| ARFCN | Absolute Radio Frequency Channel Number |
| BFD | Beam Failure Detection |
| BWP | Bandwidth Part |
| CA | Carrier Aggregation |
| CORESET | Control Resource Set |
| CC | Component Carrier |
| CCE | Control Chanel Element |
| CRC | Cyclic Redundancy Check |
| C-RNTI | Cell-Radio Network Temporary Identifier |
| CS-RNTI | Configured Scheduling-Radio Network Temporary |
| | Identifier |
| CSS | Common Search Space |
| CSI | Channel State Information |
| DC | Dual Connectivity |
| DCI | Downlink Control Information |
| DL | Downlink |
| GC-PDCCH | Group Common-Physical Downlink Control Channel |
| HARQ | Hybrid Automatic Repeat Request |
| IE | Information Element |
| IIoT | Industrial Internet of Things |
| LSB | Least Significant Bit |
| LTE | Long Term Evolution |
| LTM | Layer 1/Layer 2-Triggered Mobility |
| L1 | Layer 1 |
| MAC | Medium Access Control |
| MAC CE | MAC Control Element |
| MCG | Master Cell Group |
| MCS-C-RNTI | Modulation Coding Scheme-Cell-Radio Network |
| | Temporary Identifier |
| mTRP | Multiple Transmission Reception Point |
| MIMO | Multiple-input Multiple-output |
| MSB | Most Significant Bit |
| NACK | Negative Acknowledgment |
| NDI | New Data Indicator |
| NR | New RAT/Radio |
| NW | Network |
| NUL | Normal UL |
| PCI | Physical Cell ID |
| PCell | Primary Cell |
| PSCell | Primary Secondary Cell |
| PBCH | Physical Broadcast Channel |
| PDCCH | Physical Downlink Control Channel |
| PDSCH | Physical Downlink Shared Channel |
| PDU | Protocol Data Unit |
| PHY | Physical (layer) |
| PRACH | Physical Random Access Channel |
| PTAG | Primary Timing Advance Group |
| PUCCH | Physical Uplink Control Channel |
| PUSCH | Physical Uplink Shared Channel |
| RA | Random Access |
| RAN | Radio Access Network |
| RAR | Random Access Response |
| Rel | Release |
| RMSI | Remaining Minimum System Information |
| RNTI | Radio Network Temporary Identifier |
| RRC | Radio Resource Control |
| RRM | Radio Resource Management |
| RS | Reference Signal |
| RSRP | Reference Signal Received Power |
| RV | Redundancy Version |
| SCell | Secondary Cell |
| SCG | Secondary Cell Group |
| SCS | Subcarrier Spacing |
| SDM | Spatial Domain Multiplexing |
| SINR | Signal to Interference plus Noise Ratio |
| SpCell | Special Cell |
| SR | Scheduling Request |
| SRI | SRS resource indicator |
| SRS | Sounding Reference Signal |
| SSB | Synchronization Signal Block |
| STAG | Secondary Timing Advance Group |
| STxMP | Simultaneous Transmission on Multiple Panels |
| SUL | Supplementary UL |
| TA | Timing Advance |
| TAG | Timing Advance Group |
| TB | Transport Block |
| TBS | Transport Block |
| TCI | Transmission Configuration Indication |
| TPMI | Transmission Precoding Matrix Indicator |
| TR | Technical Report |
| TRP | Transmission Reception Point |
| TS | Technical Specification |
| QCL | Quasi-CoLocation |
| UE | User Equipment |
| UL | Uplink |
| URLLC | Ultra Reliable Low Latency Communication |
| USS | UE-Specific Search Space |
| WG | Working Group |
| WI | Working Item |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For consistency and ease of understanding, like features may be identified (although, in some examples, not illustrated) by the same numerals in the drawings. However, the features in different implementations may be different in other respects and shall not be narrowly included to what is illustrated in the drawings.

References to “one implementation,” “an implementation,” “example implementation,” “various implementations,” “some implementations,” “implementations of the present application,” etc., may indicate that the implementation(s) of the present application so described may include a particular feature, structure, or characteristic, but not every possible implementation of the present application necessarily includes the particular feature, structure, or characteristic. Further, repeated use of the phrase “in one implementation,” or “in an example implementation,” “an implementation,” do not necessarily refer to the same implementation, although they may. Moreover, any use of phrases like “implementations” in connection with “the present application” are never meant to characterize that all implementations of the present application must include the particular feature, structure, or characteristic, and should instead be understood to mean “at least some implementations of the present application” includes the stated particular feature, structure, or characteristic. The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-described combination, group, series, and the equivalent.

The expression “at least one of A, B and C” or “at least one of the following: A, B and C” means “only A, or only B, or only C, or any combination of A, B and C.” The terms “system” and “network” may be used interchangeably. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

For the purposes of explanation and non-limitation, specific details, such as functional entities, techniques, protocols, and standards, are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software, or a combination of software and hardware. Disclosed functions may correspond to modules which may be software, hardware, firmware, or any combination thereof.

A software implementation may include computer executable instructions stored on a computer-readable medium, such as memory or other type of storage devices. One or more microprocessors or general-purpose computers with communication processing capability may be programmed with corresponding executable instructions and perform the disclosed network function(s) or algorithm(s).

The microprocessors or general-purpose computers may include Application-Specific Integrated Circuits (ASICs), programmable logic arrays, and/or one or more Digital Signal Processor (DSPs). Although some of the disclosed implementations are oriented to software installed and executing on computer hardware, alternative implementations implemented as firmware, as hardware, or as a combination of hardware and software are well within the scope of the present disclosure. The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as a Long-Term Evolution (LTE) system, an LTE-Advanced (LTE-A) system, an LTE-Advanced Pro system, or a 5G NR Radio Access Network (RAN) typically includes at least one base station (BS), at least one UE, and one or more optional network elements that provide connection within a network. The UE communicates with the network, such as a Core Network (CN), an Evolved Packet Core (EPC) network, an Evolved Universal Terrestrial RAN (E-UTRAN), a 5G Core (5GC), or an internet via a RAN established by one or more BSs.

A UE may include, but is not limited to, a mobile station, a mobile terminal or device, or a user communication radio terminal. The UE may be a portable radio equipment that includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a RAN.

The BS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include, but is not limited to, a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using multiple cells forming the RAN. The BS supports the operations of the cells. Each cell is operable to provide services to at least one UE within its radio coverage.

Each cell (often referred to as a serving cell) provides services to serve one or more UEs within its radio coverage such that each cell schedules the DL and optionally UL resources to at least one UE within its radio coverage for DL and optionally UL packet transmissions. The BS may communicate with one or more UEs in the radio communication system via the plurality of cells.

A cell may allocate sidelink (SL) resources for supporting Proximity Service (ProSe) or Vehicle to Everything (V2X) service. Each cell may have overlapped coverage areas with other cells.

In Multi-RAT Dual Connectivity (MR-DC) cases, the primary cell of a Master Cell Group (MCG) or a Secondary Cell Group (SCG) may be called a Special Cell (SpCell). A Primary Cell (PCell) may include the SpCell of an MCG. A Primary SCG Cell (PSCell) may include the SpCell of an SCG. MCG may include a group of serving cells associated with the Master Node (MN), including the SpCell and optionally one or more Secondary Cells (SCells). An SCG may include a group of serving cells associated with the Secondary Node (SN), including the SpCell and optionally one or more SCells.

As previously disclosed, the frame structure for NR supports flexible configurations for accommodating various next generation (e.g., 5G) communication requirements, such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3GPP may serve as a baseline for an NR waveform. The scalable OFDM numerology, such as adaptive sub-carrier spacing, channel bandwidth, and Cyclic Prefix (CP), may also be used.

Two coding schemes are considered for NR, specifically Low-Density Parity-Check (LDPC) code and Polar Code. The coding scheme adaption may be configured based on channel conditions and/or service applications.

At least DL transmission data, a guard period, and UL transmission data should be included in a transmission time interval (TTI) of a single NR frame. The respective portions of the DL transmission data, the guard period, and the UL transmission data should also be configurable based on, for example, the network dynamics of NR. SL resources may also be provided in an NR frame to support ProSe services or V2X services.

Any two or more than two of the following paragraphs, (sub)-bullets, points, actions, behaviors, terms, or claims described in the present disclosure may be combined logically, reasonably, and properly to form a specific method.

Any sentence, paragraph, (sub)-bullet, point, action, behavior, term, or claim described in the present disclosure may be implemented independently and separately to form a specific method.

Dependency, e.g., “based on”, “more specifically”, “preferably”, “in one embodiment”, “in some implementations”, etc., in the present disclosure is just one possible example and shall not restrict the specific method.

“A and/or B” in the present disclosure may include either A or B, both A and B, at least one of A and B.

Examples of some selected terms in the present disclosure are provided as follows.

Antenna Panel: A conceptual term for UE antenna implementation. It may be assumed that a panel is an operational unit for controlling a transmission spatial filter (beam). A panel may typically include multiple antenna elements. In some implementations, a beam may be formed by a panel. To form two beams simultaneously, two panels may be needed. Such simultaneous beamforming from multiple panels may be subject to a UE's capability (may also be referred to as UE capability in this disclosure). A similar definition for “panel” may be applicable by applying spatial receiving filtering characteristics.

BWP: A subset of the total cell bandwidth of a cell may be referred to as a bandwidth part (BWP), and beamwidth part adaptation may be achieved by configuring the UE with one or more BWP(s) and informing the UE which of the configured BWPs is currently active. To enable bandwidth adaptation (BA) on the PCell, the gNB may configure the UE with both UL and DL BWPs. To enable BA on SCells in the case of carrier aggregation (CA), the gNB may configure the UE with at least DL BWP(s) (e.g., there may be none in the UL). For the PCell, the initial BWP may be the BWP used for an initial access. For the SCell(s), the initial BWP may be the BWP configured for the UE to first operate upon an SCell activation. The UE may be configured with a first active uplink BWP by an information element (IE), such as a firstActiveUplinkBWP IE. If the first active uplink BWP is configured for an SpCell, the firstActiveUplinkBWP IE field may include the ID of the UL BWP to be activated upon performing the RRC (re-)configuration. If such IE field is absent, the RRC (re-)configuration may not impose a BWP switch. If the first active uplink BWP is configured for an SCell, the firstActiveUplinkBWP IE field may include the ID of the uplink bandwidth part to be used upon a MAC activation of an SCell.

TCI state: A TCI state may include parameters for configuring a QCL relationship between one or two reference signals and a target reference signal set. For example, a target reference signal set may include the Demodulation Reference Signals (DM-RS) ports of a PDSCH, a PDCCH, a PUCCH, or a PUSCH. The one or two reference signals may be either UL or DL reference signals. In NR Rel-15/16, the TCI state may be used for a DL QCL indication, while spatial relation information may be used to provide UL spatial transmission filter information for UL signal(s) or UL channel(s). In this disclosure, a TCI state may be referred to as information similar to spatial relation information, which could be used for UL transmission. In other words, from a UL perspective, a TCI state may provide UL beam information, which may include the information for a relationship between an UL transmission and DL or UL reference signals (e.g., CSI-RS, SSB, SRS, PTRS).

Panel: UE panel information may be derived from the TCI state/UL beam indication information or the network signaling.

Beam: The term “beam” may be interpreted as a spatial filter. For example, when UE reports a preferred gNB transmission (TX) beam, the UE may be essentially selecting a spatial filter used by the gNB. The term “beam information” may be used to provide information about which beam/spatial filter is being used/selected.

When the UE moves from the coverage area of one cell to another cell, a serving cell change may need to be performed at some point to ensure that the radio connection and radio quality are maintained above a certain (threshold) level. Currently, the serving cell change may be triggered by Layer 3 (L3) measurements and may be executed through RRC signaling, which triggers a reconfiguration with synchronization for the change of the PCell and PSCell, as well as release and addition of the SCells, when applicable. All cases involve complete Layer 2 (L2) and Layer 1 (L1) resets in an L3-based mobility, leading to longer latency, larger overhead, and longer interruption time than beam switch mobility. Thus, the goal of LTM enhancements may be to enable a serving cell to be changed via L1/L2 signaling, in order to reduce the latency, overhead, and interruption time.

To reduce latency and signaling overhead due to L3 measurements, enhancements may be required for the LTM. These enhancements may include L1-based measurements and reporting, configuration and maintenance for multiple candidate cells, a dynamic switch mechanism among candidate serving cells based on L1/L2 signaling, and timing advance management. Moreover, to support L1/L2-based inter-cell mobility, both intra-frequency measurement and inter-frequency measurement may be specified, necessitating some detailed enhancements in the L1-based measurement. Therefore, the method and apparatus for measurement handling in the LTM scenarios, among others, are described in the disclosure.

When a UE moves from the coverage area of one cell to another cell, a serving cell change is required to maintain the connection and quality of service between the serving cell and the UE. The main objective of the L1/L2-based mobility is to reduce latency, and thus, the support for L1 beam management and L1-based measurements is needed to enhance the scheduling efficiency. Specifically, the UE may receive an RRC pre-configuration to obtain information about candidate cells or at least one target cell before switching to at least one target cell. Then, the UE may perform the cell switch based on a cell switch command, with some mobility latency involved.

In detail, the mobility latency may include the duration from when the UE receives the cell switch command to when the UE performs the first DL reception/transmission based on the indicated beam of the target cell. More specifically, this may include the time for processing the cell switch command (T_{cmd}+T_{processing,2}), executing DL synchronization (T_{search}+T_{Δ}+T_{margin}), executing UL synchronization (T_{IU}+T_{RAR}), and performing the first DL reception/transmission after the random access response (RAR) is received. The time may be considered as a handover interruption time. In this disclosure, T_{cmd} may include the time for processing the L1/L2 commands, T_{processing,2} may include the time for the UE processing after the cell switch command, T_{search} may include the time required to search the target cell, TA may include the time for fine tracking and acquiring full timing information, T_{margin} may include the time for the SSB or CSI-RS post-processing, T_{IU} may include the interruption uncertainty in acquiring the first available PRACH occasion in the target cell, and T_{RAR} may include the time for RAR delay. Furthermore, the decision to switch cells may depend on the L1 measurement and reporting, making it crucial to specify the procedure and method for the L1 measurement and reporting.

A source cell/BS may transmit a configuration or information associated with candidate cells to a UE via RRC signaling. After receiving the RRC pre-configuration, the UE may store and/or apply the received configuration for the LTM procedure. In some implementations, the RRC pre-configuration may include a resource allocation configuration (e.g., either time domain or frequency domain), a DL synchronization specific configuration, a UL synchronization specific configuration, a BWP configuration, a cell group configuration, a measurement configuration, a report configuration, a beam management configuration (e.g., TCI state configuration), a mobility scenarios configuration, a DL control channel specific configuration, a DL data channel specific configuration, a UL control channel specific configuration, and/or UL data channel specific configuration.

In some implementations, the UE may receive an RRC pre-configuration of all the candidate cells simultaneously. In some implementations, the UE may receive an RRC pre-configuration of each candidate cell in different timings.

During the LTM procedure, the source cell may inform a UE of cell-switching-related information via a cell switch command. In some implementations, the cell switch command may include an RRC pre-configuration, a MAC CE, or DCI. In some implementations, the cell switch command may include the IDs of candidate cells (e.g., the PCI indexes of the candidate cells, additional PCI indexes, and/or the PCI index of the serving cell), the ID of the target cell (e.g., PCI index of the target cell), RRC pre-configuration index associated with the candidate cells or the target cell, BWP information for the candidate cells or the target cell, TA information, associated reference signal information (e.g., SSB index or CSI-RS resource index), and/or TCI state configuration for the candidate cells or the target cell. After receiving the cell switch command from the source cell, the UE may switch from the serving cell to the target cell indicated in the cell switch command. In some implementations, the cell switching may include a PCell change (e.g., switch from the source PCell to the target PCell), an SCell change, and/or a PSCell change. In some implementations, the target cell may include an SCell before switching. In some implementations, the target cell may include a PSCell before switching. In some implementations, the target cell may include a non-serving cell before switching.

During the LTM procedure, a UE may execute a DL synchronization process to acquire DL time/frequency synchronization, DL system information, and/or DL data from the target cell. In some implementations, the UE may perform the DL synchronization before processing the cell switch command to reduce the interruption time. In some implementations, the UE may perform the DL synchronization after processing the cell switch command when the target cell is specifically indicated. In some implementations, the UE may receive information for the DL synchronization through an RRC pre-configuration, a MAC CE, or the DCI received from the source cell. In some implementations, the received information may include the IDs of the candidate cells (or PCIs of the candidate cells), the ID of the target cell (or PCI of the target cell), the SSB indexes associated with the candidate cells, the SSB index associated with the target cell, the time/frequency domain information for the candidate cells, the time/frequency domain information for the target cell, the CSI resource index associated with the candidate cells, the CSI resource index associated with the target cell, the TCI state configuration associated with the candidate cells, and/or the TCI state configuration associated with the target cell.

During the LTM procedure, a UE may execute a UL synchronization process to evaluate the exact timing to send the UL information/data to the target cell (e.g., timing advance acquisition). In some implementations, the UE may perform the UL synchronization after finishing the DL synchronization process. In some implementations, the UE may perform the UL synchronization before processing the cell switch command to reduce the interruption time. In some implementations, the UE may perform the UL synchronization after processing the cell switch command when the target cell is specifically indicated. In some implementations, the UE may perform a Random Access (RA) procedure (e.g., contention-based RA procedure, contention-free RA procedure, 2-step RA procedure, 4-step RA procedure) for the candidate cells or the target cell. In some implementations, the UE may perform a Random Access Channel-less (RACH-less) procedure (e.g., without performing RA procedure) for the candidate cells or the target cell. In some implementations, the UE may receive information for the UL synchronization from the RRC pre-configuration, MAC CE, or DCI received from the source cell. In some implementations, the received information may include a PRACH resource configuration associated with the candidate cells or the target cell, a preamble sequence configuration associated with the candidate cells or the target cell, the RACH procedure indication, the timing advance group index associated with the candidate cells or the target cell, the UL carrier types (NUL or SUL) for the candidate cells or the target cell, the SRS configuration associated with the candidate cells or the target cell, and/or the TCI state configuration associated with the candidate cells or the target cell.

A UE may perform and report measurements based on the received configuration or indication. The L1 measurements may be further classified as either L1 intra-frequency measurement or L1 inter-frequency measurement. In some implementations, the L1 intra-frequency measurement and L1 inter-frequency measurement may be performed based on an L1-RSRP through measuring the SSB (e.g., SS-RSRP) or CSI-RS (e.g., CSI-RSRP). In some implementations, the L1 intra-frequency measurement and L1 inter-frequency measurement may be performed based on the L1-SINR through measuring the SSB (e.g., SS-SINR) or CSI-RS (e.g., CSI-SINR). In some implementations, the L1 intra-frequency measurement and L1 inter-frequency measurement may be performed based on the L1-RSRQ through measuring the SSB (e.g., SS-RSRQ) or CSI-RS (e.g., CSI-RSRQ).

In some implementations, the L1 measurement report may include one or more PCIs (e.g., PCIs of the candidate cells, PCI of the source cell, PCI of the serving cell, or PCI of the target cell). In some implementations, the L1 measurement report may include one or more RS IDs.

In some implementations, the L1 measurement report, based on whether the UCI is transmitted on PUCCH or PUSCH, may be considered as the result of a measurement from the UE's perspective. In some implementations, the L1 measurement report, when transmitted as UCI on PUCCH or PUSCH, may be considered as the result of a measurement from the UE's perspective. In some implementations, the L1 measurement report type may include a periodic report on PUCCH, a semi-persistent report on PUCCH or PUSCH, and an aperiodic report on PUSCH. In some implementations, the L1 measurement report may be transmitted on a MAC CE.

In some implementations, the frequency of the measured RS covered by the active BWPs of the SpCell and SCells configured for a UE may be associated with an intra-frequency measurement scenario. In some implementations, the frequency of the measured RS covered by any of the configured BWPs of the SpCell and SCells configured for a UE may be associated with an intra-frequency measurement scenario. In some implementations, both the serving cell and candidate cells (or the target cell) may correspond to the same SSB center frequency and subcarrier spacing may include an intra-frequency measurement scenario. In some implementations, candidate cells (or the target cell) configured with a CSI-RS resource bandwidth which is included within the bandwidth of the CSI-RS resource bandwidth belonging to the serving cell, and both CSI-RSs using the same subcarrier spacing, may be associated with an intra-frequency measurement scenario.

In some implementations, the frequency of the measured RS not covered by the active BWPs of the SpCell and SCells configured for a UE may be associated with the inter-frequency measurement scenario. In some implementations, the frequency of the measured RS not covered by the any of the configured BWPs of SpCell and SCells configured for a UE may be associated with the inter-frequency measurement scenario. In some implementations, the scenarios not included in intra-frequency measurement scenario may be regarded as inter-frequency measurement scenario.

In some implementations, the CSI report may include one or more of the Channel Quality Indicator (CQI), Precoding Matrix Indicator (PMI), CSI-RS resource indicator (CRI), SS/PBCH block resource indicator (SSBRI), Layer Indicator (LI), Rank Indicator (RI), Capability Index, L1-RSRP, L1-SINR, and/or L1-RSRQ.

A cell in the present disclosure may include a PCell, a PSCell, a SPCell, a SCell, a candidate cell, a target cell, and/or a source cell.

Inter-cell mobility scenarios may include, but not limited to, intra-node mobility and inter-node mobility. Each scenario may correspond to an intra-DU case, an inter-DU case, an intra-CU case, and/or an inter-CU case. It should be noted that a network node (e.g., BS) may include one central unit (CU) and several distributed units (DUs). A CU may be a logical node that hosts the RRC, SDAP, and PDCP protocols of the BS or the RRC and PDCP protocols of the EN-gNB that control the operations of one or more DUs. A DU may be a logical node hosting the RLC, MAC, and PHY layers of the gNB or EN-gNB, and its operation may be partly controlled by the gNB-CU. A single DU may support one or multiple cells. The CU may connect to the several DUs via F1 interfaces.

In the intra-node mobility scenario, the serving cell and the target cell may operate on the same network node and share the same MAC entity (e.g., in a carrier aggregation scenario). It should be noted that the intra-node mobility scenario may be further classified into two cases, which may be an intra-CU with an intra-DU case and an intra-CU with an inter-DU case.

In the case of intra-CU with intra-DU, both the serving cell and the target cell may belong to the same DU and the same CU. In the case of intra-CU with inter-DU, the serving cell and the target cell may belong to the same CU but correspond to different DUs.

In the inter-node mobility scenario, the serving cell and the target cell may operate on different network nodes. A UE may apply separate MAC entities to the serving cell and the target cell (e.g., in a dual connectivity scenario). It should be noted that the serving cell may include the special cell or PCell, and the target cell may include a special cell, PSCell, or SCell.

In some implementations, the RRC pre-configuration may be associated with a set of cells corresponding to the intra-frequency scenario. More specifically, the configured RRC pre-configuration may apply to one or more cells of the configured set of cells which are considered to be operating on the intra-frequency. In some implementations, a set of cells may be configured in the RRC pre-configuration, and a set of cells may correspond to at least one candidate cell. In some implementations, a set of cells may be configured in the RRC pre-configuration, and a set of cells may correspond to at least one target cell.

In some implementations, a set of cells may be associated with a set of PCI indices or a PCI group index. For example, a PCI group may include a set of PCI indices (e.g., PCI group #1={PCI=0, 1, 2}), and each PCI group may correspond to an index. In some implementations, a set of cells may be associated with a PCI index of the serving cell and at least one additional PCI index other than the PCI index of the serving cell. In some implementations, a set of cells may be associated with a set of SSB indices or a SSB group index. For example, a SSB group may include a set of SSB indices (e.g., SSB group #1={SSB Id=0, 1, 2}), and each SSB group may correspond to an index. In some implementations, a set of cells may be associated with a set of CSI-RS indices or a CSI-RS group index. For example, a CSI-RS group may include a set of CSI-RS indices (e.g., CSI-RS group #1={CSI-RS Id=0, 1, 2}), and each CSI-RS group may correspond to an index.

In some implementations, a set of cells may correspond to the measurement with the RSs covered by the active BWPs of SpCell and SCells for a UE. For example, the RSs of the set of cells to be measured may be located in the active BWPs of SpCell and SCells of the UE. In some implementations, a set of cells may correspond to the measurement with the RSs covered by the configured BWPs of SpCell and SCells for a UE. In some implementations, a set of cells may correspond to the same SSB center frequency and subcarrier spacing. In some implementations, a set of cells may correspond to SSB included in the same ARFCN and with the same subcarrier spacing. In some implementations, a set of cells may correspond to CSI-RSs included in the same BWP and with the same subcarrier spacing. In some implementations, a set of cells may correspond to CSI-RSs included in the same ARFCN and with the same subcarrier spacing.

In some implementations, the RRC pre-configuration may be associated with a set of cells corresponding to the inter-frequency. More specifically, the configured RRC pre-configuration may apply to one or more cells of the configured set of cells which are considered to be operating on the inter-frequency. In some implementations, a set of cells may be configured in the RRC pre-configuration and correspond to at least one candidate cell. In some implementations, a set of cells may be configured in the RRC pre-configuration and correspond to at least one target cell. In some implementations, a set of cells may be associated with a set of PCI indices or a PCI group index. In some implementations, a set of cells may be associated with a PCI index of the serving cell and at least one additional PCI index other than the PCI index of the serving cell. In some implementations, a set of cells may be associated with a set of SSB indices or a SSB group index. In some implementations, a set of cells may be associated with a set of CSI-RS indices or a CSI-RS group index.

In some implementations, a set of cells may correspond to the measurement with the RSs not covered by the active BWPs of the SpCell and SCells for a UE. In some implementations, a set of cells may correspond to the measurement with the RSs not covered by the configured BWPs of SpCell and SCells for a UE. In some implementations, a set of cells may correspond to different SSB center frequencies and subcarrier spacings. In some implementations, a set of cells may correspond to different SSB center frequencies, but with the same subcarrier spacing. In some implementations, a set of cells may correspond to the SSB included in the different ARFCNs and/or subcarrier spacings. In some implementations, a set of cells may correspond to SSB included in the different ARFCNs, but with the same subcarrier spacing. In some implementations, a set of cells may correspond to the CSI-RSs not included in the same BWP and with different subcarrier spacings.

In some implementations, a set of cells may correspond to the CSI-RSs not included in the same BWP but with the same subcarrier spacing. In some implementations, a set of cells may correspond to CSI-RSs included in different ARFCNs and/or subcarrier spacings. In some implementations, a set of cells may correspond to the CSI-RSs included in the different ARFCNs, but with the same subcarrier spacing. In some implementations, RRC pre-configuration may include a first set of cells and a second set of cells, where the first set of cells may include cells corresponding to the intra-frequency and the second set of cells may include cells corresponding to the inter-frequency. In some implementations, the first set of cells and the second set of cells may correspond to different cell group indices, different PCI group indices, different SSB group indices, or different CSI-RS group indices.

In some implementations, the cells included in the first set of cells and the cells included in the second set of cells may be the same, partially different, or completely different. In some implementations, the first set of cells and the second set of cells may correspond to different CC lists. In some implementations, the first set of cells may be indicated via a list of cell IDs, PCIs, and/or cell indices. In some implementations, the second set of cells may be indicated via a list of cell IDs, PCIs, and/or cell indices. In some implementations, the first set of cells may be indicated via a first list of cell IDs, PCIs, and/or cell indices. The second set of cells may be indicated via a second list of cell IDs, PCIs, and/or cell indices. The first list may be followed by the second list. Thus, the first list and the second list may constitute a list.

In some implementations, the RRC pre-configuration may include a first measurement configuration associated with the intra-frequency cells and a second measurement configuration associated with the inter-frequency cells. In some implementations, each of the measurement configurations may correspond to a configuration index. In some implementations, a measurement configuration may be associated with a configuration index. The measurement configuration may include, or be associated with, a set of intra-frequency cells. The set of intra-frequency cells may be indicated via a list of cell IDs, PCIs, and/or cell indices. In some implementations, if the measurement configuration does not include or is not associated with a frequency index, a BWP index and/or a bandwidth range, or if the frequency indicator or frequency information in the measurement configuration or associated with the measurement configuration is absent, the measurement configuration may be regarded to be associated with the intra-frequency measurement.

In some implementations, a measurement configuration may be associated with a configuration index. The measurement configuration may include or be associated with a set of cells operating on an inter-frequency other than the serving frequency. The measurement configuration may include or be associated with a frequency index, a BWP index, and/or a bandwidth range to indicate the corresponding inter-frequency. The set of inter-frequency cells may be indicated via a list of cell IDs, PCIs, and/or cell indices.

In some implementations, the RRC pre-configuration may include at least one measurement configuration for a set of cell groups. In some implementations, each of the cell groups in the set of cell groups may correspond to a cell group index. In some implementations, each of the cell groups in the set of cell groups may correspond to different properties (e.g., intra-frequency channel measurement, intra-frequency interference measurement, inter-frequency channel measurement, inter-frequency interference measurement, intra-frequency mobility, inter-frequency mobility, or inter-cell beam management).

In some implementations, an RRC parameter may indicate whether a single measurement report includes a report corresponding to the intra-frequency and a report corresponding to the inter-frequency. It should be noted that the terms referring to a single measurement report, a single report, and a single report instance may be used interchangeably.

In some implementations, the RRC parameter may correspond to a flag with a value of 0 or 1, where the value 0 may represent that the report (only) corresponds to one of the intra-frequency measurement and inter-frequency measurement, and the value 1 may represent that the report corresponds to both the intra-frequency measurement and inter-frequency measurement. In some implementations, the value 1 may represent that the report (only) corresponds to one of the intra-frequency measurement and inter-frequency measurement, and the value 0 may represent that the report corresponds to both the intra-frequency measurement and inter-frequency measurement.

In some implementations, the RRC parameter may correspond to a flag being set to ‘true’ or ‘false’, where ‘true’ may represent that the report (only) corresponds to one of the intra-frequency measurement and inter-frequency measurement, and ‘false’ may represent that the report corresponds to both the intra-frequency measurement and inter-frequency measurement. In some implementations, ‘false’ may represent that the report (only) corresponds to one of the intra-frequency measurement and inter-frequency measurement, and ‘true’ may represent that the report corresponds to both the intra-frequency measurement and inter-frequency measurement.

In some implementations, the RRC parameter may correspond to a specific instruction (e.g., ‘intra-frequency’, ‘inter-frequency’, or ‘intra-frequency and inter-frequency’), where ‘intra-frequency’ may represent that the report corresponds to the intra-frequency measurement, ‘inter-frequency’ may represent that the report corresponds to the inter-frequency measurement, and ‘intra-frequency and inter-frequency’ may represent that the report corresponds to both the intra-frequency measurement and inter-frequency measurement.

In some implementations, the RRC parameter may be based on whether the RRC parameter is associated with the inter-frequency measurement. For example, if the RRC parameter is configured, present, enabled, set as a bit having the value ‘1’, or set as ‘true’, the single measurement report may include a report corresponding to both the intra-frequency and inter-frequency measurements. In some implementations, the RRC parameter may be based on whether the RRC parameter is associated with the inter-frequency measurement. For example, if the RRC parameter is configured, present, enabled, set as a bit having the value ‘1’, or set as ‘true’, the single measurement report may include a report corresponding to the inter-frequency measurement only. In some implementations, the RRC parameter may be based on whether the RRC parameter is associated with the inter-frequency measurement. For example, if the RRC parameter is not configured, absent, disabled, set as a bit having the value ‘0’, or set as ‘false’, the single measurement report may include a report corresponding to the intra-frequency measurement only. In some implementations, the RRC parameter may be in ENUMERATED format {‘intra-frequency’, ‘inter-frequency’, ‘both’}.

In some implementations, the measurement configuration for the intra-frequency and inter-frequency may correspond to different indices. A first range of indices may correspond to the measurement configuration for the intra-frequency measurement, while a second range of indices may correspond to the measurement configuration for the inter-frequency measurement, where the first range and the second range may be disjoint. More specifically, if there are 64 measurement configurations for a UE, the measurement configuration with indexes 0-31 may correspond to the intra-frequency, and the measurement configuration with indexes 32-64 may correspond to the inter-frequency.

In some implementations, a MAC CE may include at least one field to indicate that a cell is associated with the intra-frequency or inter-frequency, where the cell may include a candidate cell, a target cell, a neighbouring cell, SCell, PSCell, and/or Spcell. In some implementations, the at least one field may include ‘intra’, ‘inter’, or ‘both’. In some implementations, the at least one field may be represented by two bits. For example, ‘11’ may represent ‘both’, ‘10’ may represent ‘inter’, ‘01’ may represent ‘intra’, and ‘00’ may represent reserved bits for future use. In some implementations, the at least one field may include ‘intra-only’ or ‘both’. In some implementations, the at least one field may be represented as a bit. For example, ‘I’ may represent ‘both’ and ‘0’ may represent ‘intra-only.

In some implementations, if a field or an indicator in a MAC CE used to indicate the intra-frequency measurement is absent, a UE may report the inter-frequency measurement result only. In some implementations, if a field or an indicator in a MAC CE used to indicate the inter-frequency measurement is absent, a UE may report the intra-frequency measurement result only. In some implementations, if a field or an indicator in a MAC CE used to indicate both the intra-frequency measurement and inter-frequency measurement is absent, a UE may report the channel quality indicator (CQI), precoding matrix indicator (PMI), CSI-RS resource indicator (CRI), SS/PBCH block resource indicator (SSBRI), layer indicator (LI), rank indicator (RI), and/or capability index, without the intra-frequency and inter-frequency measurement report.

In some implementations, a MAC CE may include at least one field to indicate that a measurement report is associated with the intra-frequency or inter-frequency. In some implementations, the at least one field with the value 0 may represent that the corresponding report is for the intra-frequency measurement, and the value 1 may represent that the corresponding report is for the inter-frequency measurement. In some implementations, the field with the value 1 may represent that the corresponding report is for the intra-frequency measurement, and with the value 0 may represent that the corresponding report is for the inter-frequency measurement.

In some implementations, the MAC CE may include one or more fields, and each of the one or more fields may correspond to a cell to indicate the corresponding report is for the intra-frequency or inter-frequency the for the cell. For example, a first cell may correspond to the first field with a value ‘0’, and a second cell may correspond to the second field with a value ‘l’. The first cell may be indicated that the corresponding report is for the intra-frequency measurement, and the second cell may be indicated that the corresponding report is for inter-frequency measurement. In some implementations, the at least one field may correspond to a cell group index, a PCI group index, a SSB group index, and/or a CSI-RS group index.

In some implementations, a dedicated MAC CE (e.g., the intra-frequency measurement MAC CE) may be used to indicate the intra-frequency measurement report. In some implementations, the intra-frequency dedicated MAC CE may include cells that are considered to operate on the intra-frequency. In some implementations, the intra-frequency dedicated MAC CE may be associated with the intra-frequency measurement configuration or a measurement configuration with a specific index to identify the intra-frequency measurement. For example, the dedicated MAC CE may include the specific index. The intra-frequency measurement configuration or the measurement configuration with a specific index may be included in the RRC (pre)configuration. The specific index in the MAC CE may be associated with the specific index indicating the corresponding intra-frequency measurement configuration or the measurement configuration with a specific index configured in RRC (pre)configuration.

In some implementations, the intra-frequency dedicated MAC CE may be cell-specific, frequency carrier specific, cell-group specific, PCI-group specific, BWP specific, BWP-group specific, SSB specific, SSB-group specific, CSI-RS specific, or CSI-RS-group specific.

For example, if the MAC CE is cell-specific, a UE associated with the cell that the MAC CE indicates may apply the intra-frequency measurement. For example, if the MAC CE is cell group-specific, a UE associated with a set of cells in the cell group that the MAC CE indicates may apply the intra-frequency measurement. For example, if the MAC CE is frequency carrier-specific, a UE associated with the cells sharing the same frequency carrier that the MAC CE indicates may apply the intra-frequency measurement. For example, if the MAC CE is BWP-specific, a UE with active/configured BWP that the MAC CE indicates may apply the intra-frequency measurement. For example, if the MAC CE is BWP group-specific, a UE with active/configured BWPs in the same BWP group that the MAC CE indicates may apply the intra-frequency measurement.

For example, if the MAC CE is SSB specific, a UE with RSs associated with SSBs that the MAC CE indicates may apply the intra-frequency measurement. For example, if the MAC CE is SSB group-specific, a UE with RSs associated with SSBs in the SSB group that the MAC CE indicates may apply the intra-frequency measurement. For example, if the MAC CE is CSI-RS specific, a UE with RSs associated with CSI-RS that the MAC CE indicates may apply the intra-frequency measurement. For example, if the MAC CE is CSI-RS group-specific, a UE with RSs associated with CSI-RSs in the CSI-RS group that the MAC CE indicates may apply the intra-frequency measurement.

In some implementations, a dedicated MAC CE (e.g., the inter-frequency measurement MAC CE) may be used to indicate the inter-frequency measurement report. In some implementations, the intra-frequency dedicated MAC CE may include cells that are considered to operate on the inter-frequency. In some implementations, the inter-frequency dedicated MAC CE may be associated with the inter-frequency measurement configuration or a measurement configuration with a specific index to identify the inter-frequency measurement. For example, the dedicated MAC CE may include the specific index. The inter-frequency measurement configuration or the measurement configuration with a specific index may be included in the RRC (pre)configuration. The specific index in the MAC CE may be associated with the specific index indicating the corresponding the inter-frequency measurement configuration or the measurement configuration with a specific index configured in RRC (pre)configuration.

In some implementations, the dedicated inter-frequency MAC CE may be cell-specific, frequency carrier specific, cell-group specific, PCI-group specific, BWP specific, BWP-group specific, SSB-group specific, or CSI-RS-group specific.

For example, if the MAC CE is cell-specific, a UE associated with the cell that the MAC CE indicates may apply the inter-frequency measurement. For example, if the MAC CE is cell group-specific, a UE associated with a set of cells in the cell group that the MAC CE indicates may apply the inter-frequency measurement. For example, if the MAC CE is frequency carrier-specific, a UE associated with the cells sharing the same frequency carrier that the MAC CE indicates may apply the inter-frequency measurement. For example, if the MAC CE is BWP-specific, a UE with active/configured BWP that the MAC CE indicates may apply the inter-frequency measurement. For example, if the MAC CE is BWP group-specific, a UE with active/configured BWPs in the same BWP group that the MAC CE indicates may apply the inter-frequency measurement.

For example, if the MAC CE is SSB specific, a UE with RSs associated with SSBs that the MAC CE indicates may apply the inter-frequency measurement. For example, if the MAC CE is SSB group-specific, a UE with RSs associated with SSBs in the SSB group that the MAC CE indicates may apply the inter-frequency measurement. For example, if the MAC CE is CSI-RS specific, a UE with RSs associated with CSI-RS that the MAC CE indicates may apply the inter-frequency measurement. For example, if the MAC CE is CSI-RS group-specific, a UE with RSs associated with CSI-RSs in the CSI-RS group that the MAC CE indicates may apply the inter-frequency measurement.

In some implementations, a MAC CE may be used to activate/deactivate the function that indicates a UE to report the intra-frequency and inter-frequency measurements in a single report. It should be noted that the terms referring to a single measurement report, a single report, and a single report instance may be used interchangeably. In some implementations, the MAC CE may include at least one field with the value 1 to activate the function and with the value 0 to deactivate the function. In some implementations, the MAC CE may include at least one field with the value 0 to activate the function and with the value 1 to deactivate the function. In some implementations, the MAC CE may include one or more fields, and each of field may correspond to a cell to indicate that the activation/deactivation of measurement for the cell.

In some implementations, a MAC CE may include few fields to indicate the activation/deactivation of the intra-frequency and inter-frequency status for each cell. For example, one field representing the intra-frequency measurement indication with a bit value ‘1’ may indicate the activation of the intra-frequency measurement and a bit value ‘0’ may indicate the deactivation of the intra-frequency measurement, and one field representing the inter-frequency measurement indication with a bit value ‘1’ may indicate the activation of the inter-frequency measurement and a bit value ‘0’ may indicate the deactivation of the inter-frequency measurement.

In some implementations, DCI may include at least one field to indicate that a cell is associated with the intra-frequency or inter-frequency, where the cell may include a candidate cell, a target cell, a neighboring cell, SCell, PSCell, and/or an Spcell. In some implementations, the at least one field with the value 0 may indicate the intra-frequency and the value 1 may indicate the inter-frequency. In some implementations, the at least one field with the value 1 may indicate the intra-frequency, and the value 0 may indicate the inter-frequency.

In some implementations, the at least one field may include a bitmap, and each bit may indicate the intra-frequency or inter-frequency for each cell. A bit having the value 0 may indicate the intra-frequency and the value 1 may indicate the inter-frequency. In some implementations, the bit having the value 1 may indicate the intra-frequency and the value 0 may indicate the inter-frequency.

In some implementations, the at least one field may include a codepoint, and each codepoint value may represent the intra-frequency report only, inter-frequency report only, both intra-frequency and inter-frequency report, no report, respectively. For example, codepoint ‘00’ may indicate, but not limited to, the intra-frequency report, codepoint ‘01’ may indicate, but not limited to, the inter-frequency report, codepoint ‘10’ may indicate, but not limited to, both the intra-frequency and inter-frequency report, codepoint ‘11’ may indicate, but not limited to, no report required.

In some implementations, the DCI may schedule information for other cells that are different from the serving cell. Thus, the at least one field may indicate one or more reports for one or more corresponding cells. In some implementations, the DCI may include at least one field to indicate that a report is associated with the intra-frequency, inter-frequency, or both intra-frequency and inter-frequency. In some implementations, the at least one field with the value 0 may indicate one of the intra-frequency and inter-frequency and the value 1 may indicate both the intra-frequency and inter-frequency. In some implementations, the value 1 may indicate one of the intra-frequency and inter-frequency, and the value 0 may indicate both the intra-frequency and inter-frequency. In some implementations, the at least one field with bitfield ‘00’ may indicate the intra-frequency report, bitfield ‘01’ may indicate the inter-frequency report, and bitfield ‘10’ may indicate both the intra-frequency report and inter-frequency report.

In some implementations, the DCI with CRC scrambled by a specific RNTI (e.g., RNTI for identifying LTM scheduling) may be used to indicate a report for the intra-frequency. In some implementations, the DCI with the CRC scrambled by a specific RNTI (e.g., RNTI for identifying LTM scheduling) may be used to indicate a report for the inter-frequency. In some implementations, the DCI with a specific format (e.g., a DCI format for identifying LTM scheduling) may be used to indicate a report for the intra-frequency. In some implementations, the DCI with a specific format (e.g., a DCI format for identifying LTM scheduling) may be used to indicate a report for the inter-frequency.

In some implementations, the DCI transmitted on the LTM-specific search space (e.g., a search space configured to a UE in the RRC (pre-)configuration for LTM) may be used to indicate a report for the intra-frequency. In some implementations, the DCI transmitted on the LTM-specific search space (e.g., a search space configured to a UE in the RRC (pre-)configuration for LTM) may be used to indicate a report for the inter-frequency. In some implementations, the DCI transmitted on the common search space/UE-specific search space may be used to indicate a report for the intra-frequency. In some implementations, the DCI transmitted on the common search space/UE-specific search space may be used to indicate a report for the inter-frequency.

In some implementations, a UE may report a UE capability to inform the BS whether a single report instance is supported for both the intra-frequency and inter-frequency. It should be noted that the terms referring to a single measurement report, a single report, and a single report instance, may be used interchangeably.

In some implementations, if the UE capability is reported as supported, the BS may configure, to the UE, the intra-frequency report, inter-frequency report, or both intra-frequency report and inter-frequency report. In some implementations, a UE may report a UE capability to inform the BS whether a single report instance is supported for the intra-frequency only or inter-frequency only. In some implementations, a UE may report a UE capability to inform the BS whether the UE supports measuring cells corresponding to the intra-frequency and inter-frequency simultaneously.

In some implementations, the BS (e.g., the source cell, the serving cell) may request the UE to report its UE capability regarding the intra-frequency and inter-frequency measurements and reports in the LTM via an RRC message (e.g., UECapabilityEnquiry message). In response to the reception of the RRC message (e.g., UECapabilityEnquiry message), the UE may report its UE capability regarding the intra-frequency and inter-frequency measurements and reports in the LTM, to the BS, via an RRC message (e.g., UECapabilityInformation message).

In some implementations, the RRC pre-configuration may include an SSB resource-based configuration for the intra-frequency measurement. In some implementations, the SSB resource-based configuration for the intra-frequency measurement may include at least an SSB index, an SSB monitoring periodicity and offset, an associated PCI index, an associated BWP index, an associated report configuration, an SSB resource allocation, and/or an SSB measurement duration. In some implementations, the SSB resource-based configuration may correspond to the SSB resource for the serving cell. In some implementations, the SSB resource-based configuration for the intra-frequency measurement may correspond to the SSB resource for the candidate cells other than the serving cell. In some implementations, the SSB resource-based configuration for the intra-frequency measurement may correspond to the resources for the LTM, inter-cell beam management, inter-cell mobility, low mobility scenarios, and/or high mobility scenarios.

In some implementations, whether to apply the SSB resource-based configuration for the intra-frequency measurement may be based on one or more criteria. The criteria may include whether at least one candidate cell is considered to operate on the intra-frequency, whether the number of the candidate cells is larger than a threshold value, whether the number of the candidate cells is smaller than a threshold value, and/or whether a certain UE capability is reported. For example, the threshold value may be preconfigured. For example, the threshold value may be predefined to be a specific value. For example, the UE may be configured with the threshold value via an RRC message, and/or via the SSB resource-based configuration for the intra-frequency measurement.

In some implementations, if the SSB resource-based configuration for the intra-frequency is not applied, a UE may apply the CSI-RS resource-based configuration for the intra-frequency measurement. In some implementations, the SSB in the SSB resource configuration may be included in the active BWP for a UE. In some implementations, the SSB in the SSB resource configuration may be included in the configured BWP for a UE.

In some implementations, the RRC pre-configuration may include a CSI-RS resource-based configuration for the intra-frequency measurement. In some implementations, the CSI-RS resource-based configuration for the intra-frequency measurement may include at least a CSI-RS resource index, a CSI-RS resource monitoring periodicity and offset, an associated PCI index, an associated BWP index, an associated SSB resource, an associated report configuration, an associated CSI-RS measurement purpose (e.g., for channel measurement, for interference measurement, for beam management, for LTM), a CSI-RS resource mapping, and/or a CSI-RS measurement duration. In some implementations, the CSI-RS resource-based configuration for the intra-frequency measurement may correspond to a CSI-RS resource for the serving cell. In some implementations, the CSI-RS resource-based configuration for the intra-frequency measurement may correspond to a CSI-RS resource for the candidate cells other than the serving cell. In some implementations, the CSI-RS resource-based configuration for the intra-frequency measurement may correspond to resources for LTM, inter-cell beam management, inter-cell mobility, low mobility scenarios, and/or high mobility scenarios.

In some implementations, whether to apply the CSI-RS resource-based configuration for the intra-frequency measurement may be based on one of more criteria. The criteria may include whether at least one candidate cell is considered as intra-frequency, whether the number of the candidate cells is larger than a threshold value, whether the number of the candidate cells is smaller than a threshold value, and/or whether a certain UE capability is reported. For example, the threshold value is preconfigured. For example, the threshold value may be predefined to be a specific value. For example, the UE may be configured with the threshold value via an RRC message, and/or via the CSI-RS resource-based configuration for the intra-frequency measurement.

In some implementations, if the CSI-RS resource-based configuration for the intra-frequency is not applied, a UE may apply the SSB resource-based configuration for the intra-frequency measurement. In some implementations, the CSI-RS in the CSI-RS resource configuration may be included in the active BWP for a UE. In some implementations, the CSI-RS in the CSI-RS resource configuration may be included in the configured BWP for a UE.

In some implementations, the RRC pre-configuration may include a SSB resource-based configuration, and an RRC configuration may include CSI-RS resource-based configuration for the intra-frequency measurement. It should be noted that the RRC pre-configuration may include a configuration specific to LTM procedure. In some implementations, the SSB resource-based configuration for the intra-frequency measurement may apply to the serving cell (only). In some implementations, the SSB resource-based configuration for the intra-frequency measurement may apply to the one or a set of candidate cells.

In some implementations, the CSI-RS resource-based configuration for the intra-frequency measurement may apply to the serving cell (only). In some implementations, the CSI-RS resource-based configuration for the intra-frequency measurement may apply to the one or a set of candidate cells. In some implementations, the SSB and CSI-RS may be included in the active BWP for a UE. In some implementations, the SSB and CSI-RS may be included in the configured BWP for a UE.

In some implementations, the RRC pre-configuration may include the information of candidate cells and a measurement configuration of the serving cell. Moreover, the RRC configuration may provide at least one measurement configuration associated with the candidate cells (the target cell) which are operating on the intra-frequency with the serving cell. In some implementations, the measurement configuration for the intra-frequency measurement of the serving cell may be applied to the candidate cells. In some implementations, the at least one measurement configuration for the intra-frequency measurement for the candidate cells may be the same or different. If more than one measurement configurations for the intra-frequency measurement are different, each of the measurement configurations may correspond to a specific index.

In some implementations, a measurement configuration for the intra-frequency may be associated with one or more PCIs. In some implementations, more than one PCI may include a PCI list. In some implementations, a measurement configuration for the intra-frequency may be associated with one or more cell groups. In some implementations, a cell group may include a group with the intra-frequency cells. In some implementations, a cell group may include a master cell group (MCG). In some implementations, a cell group may include a secondary cell group (SCG).

In some implementations, a measurement configuration for the intra-frequency may be associated with one or more BWPs. In some implementations, more than one BWP may include a BWP list. In some implementations, a measurement configuration for the intra-frequency may be associated with one frequency range and/or an ARFCN. In some implementations, the frequency range and/or ARFCN may include frequency range 1. In some implementations, the frequency range and/or ARFCN may include frequency range 2. In some implementations, the frequency range and/or ARFCN may include a frequency range for the intra-frequency.

In some implementations, a MAC CE may be used to activate/deactivate at least one measurement configuration for the intra-frequency measurement. In some implementations, the UE may be (pre)configured with at least one measurement configuration for the intra-frequency measurement via an RRC message received from the source cell (or the serving cell). The UE may receive the MAC CE from the source cell (or the serving cell) to activate/deactivate one or more of the at least one measurement configuration for the intra-frequency measurement. In some implementations, the MAC CE may include at least one field to indicate the corresponding measurement configuration index for the intra-frequency. For example, if the target activation of measurement configuration is the third measurement configuration, the at least one field may include bitfield ‘10’.

In some implementations, the MAC CE may include at least one field with one bit width to indicate the activation of the measurement configuration for the intra-frequency with a bit having the value 1 and indicate the deactivation of the measurement configuration for intra-frequency with a bit having the value 0. For example, if a first measurement configuration associated with a first cell corresponds to a bit having the value 1, a second measurement configuration associated with a second cell corresponds to a bit having the value 1, a third measurement configuration associated with a third cell corresponds to a bit having the value 0, and a fourth measurement configuration associated with a fourth cell corresponds to a bit having the value 0, the UE may measure the first cell and the second cell based on the corresponding measurement configuration. In some implementations, the MAC CE may include at least one field with one bitwidth to indicate the activation of the measurement configuration for the intra-frequency with a bit having the value 0 and indicate the deactivation of the measurement configuration for the intra-frequency with a bit having the value 1.

In some implementations, the MAC CE may activate/deactivate the measurement configuration for the intra-frequency associated with a cell group, a PCI group, a BWP group, and/or a frequency group. For example, the MAC CE may include the index associated with the measurement configuration for the intra-frequency to be activated/deactivated, and/or the information indicating the cell group, PCI group, BWP group, and/or the frequency group. For example, the MAC CE may include the information indicating the cell group, PCI group, BWP group and/or the frequency group. Based on the information, the UE may activate/deactivate the measurement configuration for the intra-frequency associated with the cell group, the PCI group, the BWP group, and/or the frequency group indicated by the information.

In some implementations, a MAC CE may be used to activate/deactivate at least one report configuration for the intra-frequency measurement. In some implementations, the MAC CE may include at least one field to indicate the activation of corresponding report configuration index for the intra-frequency. For example, if the target activation of report configuration is the second report configuration, the at least one field may include bitfield ‘01’. In some implementations, the MAC CE may include at least one field to indicate the deactivation of corresponding report configuration index for the intra-frequency. For example, if the target deactivation of report configuration is the third report configuration, the at least one field may include bitfield ‘10’.

In some implementations, the MAC CE may include at least one field with one bitwidth to indicate the activation of the report configuration for the intra-frequency with a bit having the value 1 and indicate the deactivation of the report configuration for the intra-frequency with a bit having the value 0. For example, if a first report configuration associated with a first cell corresponds to a bit having the value 0, a second report configuration associated with a second cell corresponds to a bit having the value 0, a third report configuration associated with a third cell corresponds to a bit having the value 1, and a fourth report configuration associated with a fourth cell corresponds to a bit having the value 1, the UE may measure the third cell and the fourth cell based on the corresponding report configuration. In some implementations, the MAC CE may include at least one field with one bitwidth to indicate the activation of the report configuration for the intra-frequency with a bit having the value 0 and indicate the deactivation of the report configuration for the intra-frequency with a bit having the value 1.

In some implementations, the MAC CE may activate/deactivate the report configuration for the intra-frequency associated with a cell group, a PCI group, a BWP group, and/or a frequency group. In some implementations, the MAC CE may deactivate the report configuration for the intra-frequency associated with a cell group, a PCI group, a BWP group, and/or a frequency group. In some implementations, a MAC CE may activate/deactivate at least one measurement configuration and at least one report configuration for the intra-frequency when they are associated with each other. For example, if a report configuration is associated with a measurement configuration, the activation/deactivation signaling may apply to both the measurement configuration and report configuration.

In some implementations, the report configuration index may be included in the measurement configuration for intra-frequency. In some implementations, the measurement configuration index may be included in the report configuration for intra-frequency. In some implementations, a MAC CE may be used to trigger at least one intra-frequency report or measurement.

In some implementations, the triggering MAC CE may be used to activate/deactivate a semi-persistent measurement configuration for the intra-frequency. More specifically, when the triggering MAC CE indicates an activation of a semi-persistent measurement configuration, a UE may start a periodic measurement based on the measurement configuration for the intra-frequency. In some implementations, when the triggering MAC CE indicates a deactivation of a semi-persistent measurement configuration, a UE may stop the periodic measurement based on the measurement configuration for the intra-frequency.

It should be noted that the UE may be configured (or may receive the configuration of) the semi-persistent measurement for the intra-frequency via an RRC message from the source cell (or the serving cell).

In some implementations, the triggering MAC CE may be used to activate/deactivate a semi-persistent report configuration for the intra-frequency. More specifically, when the triggering MAC CE indicates an activation of a semi-persistent measurement configuration, a UE may start a periodic report based on the report configuration for the intra-frequency. In some implementations, when the triggering MAC CE indicates a deactivation of a semi-persistent report configuration, a UE may stop the periodic report based on the report configuration for the intra-frequency.

It should be noted that the UE may be configured with (or may receive the configuration of) the report configuration for the intra-frequency via an RRC message from the source cell (or the serving cell).

In some implementations, the DCI may include a field to request a report for the intra-frequency measurement. In some implementations, the 1-bit bitfield with the value 1 may indicate the triggering of an aperiodic report for the intra-frequency measurement and a bitfield with a value of 0 may indicate transmitting data without the aperiodic report for the intra-frequency measurement. In some implementations, the field may include a report configuration index for the intra-frequency measurement. In some implementation, the DCI with CRC scrambled by a specific CRC (e.g., RNTI for identifying LTM scheduling) may be used to request a report for the intra-frequency measurement. In some implementation, a specific DCI format (e.g., a format for identifying LTM scheduling) may be used to request a report for the intra-frequency measurement. In some implementations, the DCI transmitted on the LTM-specific search space (e.g., a search space configured to a UE in the RRC (pre-)configuration for LTM) may be used to request a report for the intra-frequency measurement. In some implementations, the DCI transmitted on the common search space/UE-specific search space may be used to request a report for the intra-frequency measurement.

In some implementations, a UE may report a UE capability to inform the BS whether to support the intra-frequency measurement. In some implementations, the UE may receive at least one measurement configuration for the intra-frequency measurement if the UE reports the support of the intra-frequency measurement. In some implementations, a UE may report a UE capability to inform the BS whether to support the intra-frequency report generation. In some implementations, the UE may receive at least one report configuration for the intra-frequency measurement if the UE reports the support of the intra-frequency report generation. In some implementations, the BS (e.g., the source cell, the serving cell) may request the UE to report its UE capability regarding whether the UE supports the intra-frequency measurement and report in LTM, via an RRC message (e.g., UECapabilityEnquiry message). In response to the reception of the RRC message (e.g., UECapabilityEnquiry message), the UE may report its UE capability regarding whether the UE supports the intra-frequency measurement and report in LTM, to the BS, via an RRC message (e.g., UECapability Information message).

In some implementations, the RRC pre-configuration may include a SSB resource-based configuration for the inter-frequency measurement. In some implementations, the SSB resource-based configuration for the inter-frequency measurement may include at least SSB index, SSB monitoring periodicity and offset, associated PCI index, associated BWP index, associated report configuration, SSB resource allocation, and/or SSB measurement duration. In some implementations, the SSB resource-based configuration for the inter-frequency measurement may correspond to SSB resource for the serving cell. In some implementations, the SSB resource-based configuration for the inter-frequency measurement may correspond to SSB resource for the candidate cells other than the serving cell. In some implementations, the SSB resource-based configuration for the inter-frequency measurement may correspond to resources for LTM, inter-cell beam management, inter-cell mobility, low mobility scenarios, and/or high mobility scenarios.

In some implementations, whether to apply the SSB resource-based configuration for the intra-frequency measurement may be based on some criteria. The criteria may include whether at least one candidate cell is considered as inter-frequency, whether the number of the candidate cells is larger than a threshold value, whether the number of the candidate cells is smaller than a threshold value, and/or whether a certain UE capability is reported. For example, the threshold value may be preconfigured. For example, the threshold value may be predefined to be a specific value. For example, the UE may be configured with the threshold value via an RRC message, and/or via the SSB resource-based configuration for the inter-frequency measurement.

In some implementations, if the SSB resource-based configuration for the inter-frequency is not applied, a UE may apply CSI-RS resource-based configuration for the intra-frequency measurement. In some implementations, the SSB in the SSB resource configuration may be out of the active BWP for a UE. In some implementations, the SSB in the SSB resource configuration may be out of the configured BWP for a UE. In some implementations, the RRC pre-configuration may include a CSI-RS resource-based configuration for the inter-frequency measurement.

In some implementations, the CSI-RS resource-based configuration for the inter-frequency measurement may include at least CSI-RS resource index, CSI-RS resource monitoring periodicity and offset, associated PCI index, associated BWP index, associated SSB resource, associated report configuration, associated CSI-RS measurement purpose (e.g., for channel measurement, for interference measurement, for beam management, for LTM), CSI-RS resource mapping, and/or CSI-RS measurement duration. In some implementations, the CSI-RS resource-based configuration for inter-frequency measurement may correspond to CSI-RS resource for the serving cell. In some implementations, the CSI-RS resource-based configuration for the inter-frequency measurement may correspond to CSI-RS resource for the candidate cells other than the serving cell. In some implementations, the CSI-RS resource-based configuration for the inter-frequency measurement may correspond to resources for LTM, inter-cell beam management, inter-cell mobility, low mobility scenarios, and/or high mobility scenarios.

In some implementations, whether to apply the CSI-RS resource-based configuration for the inter-frequency measurement may be based on some criteria. The criteria may include whether at least one candidate cell is considered as inter-frequency, whether the number of the candidate cells is larger than a threshold value, whether the number of the candidate cells is smaller than a threshold value, and/or whether a certain UE capability is reported. For example, the threshold value may be preconfigured. For example, the threshold value may be predefined to be a specific value. For example, the UE may be configured with the threshold value via an RRC message, and/or via the CSI-RS resource-based configuration for the inter-frequency measurement. In some implementations, if the CSI-RS resource-based configuration for the intra-frequency is not applied, a UE may apply SSB resource-based configuration for the intra-frequency measurement. In some implementations, the CSI-RS in the CSI-RS resource configuration may be out of the active BWP for a UE. In some implementations, the CSI-RS in the CSI-RS resource configuration may be out of the configured BWP for a UE.

In some implementations, the RRC pre-configuration may include a SSB resource-based configuration, and an RRC configuration may include CSI-RS resource-based configuration for the inter-frequency measurement. It should be noted that the RRC pre-configuration may include a configuration specific to LTM procedure. In some implementations, the SSB resource-based configuration for the inter-frequency measurement may apply to the serving cell (only). In some implementations, the SSB resource-based configuration for the inter-frequency measurement may apply to the one or a set of candidate cells.

In some implementations, the CSI-RS resource-based configuration for the inter-frequency measurement may apply to the serving cell (only). In some implementations, the CSI-RS resource-based configuration for the inter-frequency measurement may apply to the one or a set of candidate cells. In some implementations, the SSB and CSI-RS may be out of the active BWP for a UE. In some implementations, the SSB and CSI-RS may be out of the configured BWP for a UE.

In some implementations, the RRC pre-configuration may include information of candidate cells and a measurement configuration of the serving cell. Moreover, the RRC configuration may provide the measurement configuration associated with the candidate cells (the target cell) which are the inter-frequency with the serving cell. It should be noted that the RRC pre-configuration may include a configuration specific to LTM procedure. In some implementations, the measurement configuration for the inter-frequency measurement of the serving cell may be applied to the candidate cells. In some implementations, the at least one measurement configuration for the inter-frequency measurement for the candidate cells may be the same or different. If more than one measurement configurations for the inter-frequency measurement are different, each of measurement configurations may correspond to a specific index.

In some implementations, a measurement configuration for the inter-frequency may be associated with one or more PCIs. In some implementations, more than one PCI may include a PCI list. In some implementations, a measurement configuration for the inter-frequency may be associated with one or more cell groups. In some implementations, a cell group may include a group with inter-frequency cells. In some implementations, a cell group may include a master cell group (MCG). In some implementations, a cell group may include a secondary cell group (SCG).

In some implementations, a measurement configuration for the inter-frequency may be associated with one or more BWPs. In some implementations, more than one BWP may include a BWP list. In some implementations, a measurement configuration for the inter-frequency may be associated with one frequency range and/or ARFCN. In some implementations, the frequency range and/or ARFCN may include frequency range 1. In some implementations, the frequency range and/or ARFCN may include frequency range 2. In some implementations, the frequency range and/or ARFCN may include a frequency range for the inter-frequency.

In some implementations, a MAC CE may be used to activate/deactivate at least one measurement configuration for the inter-frequency measurement. In some implementations, the UE may be (pre)configured with at least one measurement configuration for the inter-frequency measurement via an RRC message received from the source cell (or the serving cell). The UE may receive the MAC CE from the source cell (or the serving cell) to activate/deactivate one or more of the at least one measurement configurations for the inter-frequency measurement. In some implementations, the MAC CE may include at least one field to indicate the corresponding measurement configuration index for the inter-frequency. For example, if the target activation of measurement configuration is the third measurement configuration, the at least one field may include bitfield ‘10’.

In some implementations, the MAC CE may include at least one field with one bit width to indicate the activation of the measurement configuration for the inter-frequency with a bit having the value 1 and indicate the deactivation of the measurement configuration for the inter-frequency with a bit having the value 0. For example, if a first measurement configuration associated with a first cell corresponds to a bit having the value 1, a second measurement configuration associated with a second cell corresponds to a bit having the value 1, a third measurement configuration associated with a third cell corresponds to a bit having the value 0, and a fourth measurement configuration associated with a fourth cell corresponds to a bit having the value 0, the UE may measure the first cell and the second cell based on the corresponding measurement configuration. In some implementations, the MAC CE may include at least one field with one bitwidth to indicate the activation of the measurement configuration for the inter-frequency with a bit having the value 0 and indicate the deactivation of the measurement configuration for the inter-frequency with a bit having the value 1.

In some implementations, the MAC CE may activate/deactivate the measurement configuration for the inter-frequency associated with a cell group, a PCI group, a BWP group, and/or a frequency group. For example, the MAC CE may include the index associated with the measurement configuration for the inter-frequency to be activated/deactivated, and/or the information indicating the cell group, PCI group, BWP group, and/or the frequency group. For example, the MAC CE may include the information indicating the cell group, PCI group, BWP group, and/or the frequency group. Based on the information, the UE may activate/deactivate the measurement configuration for the inter-frequency associated with the cell group, the PCI group, the BWP group, and/or the frequency group indicated by the information.

In some implementations, a MAC CE may be used to activate/deactivate at least one report configuration for the inter-frequency measurement. In some implementations, the MAC CE may include at least one field to indicate the activation of corresponding report configuration index for the inter-frequency. For example, if the target activation of report configuration is the second report configuration, the at least one field may include bitfield ‘01’. In some implementations, the MAC CE may include at least one field to indicate the deactivation of corresponding report configuration index for the inter-frequency. For example, if the target deactivation of report configuration is the third report configuration, the at least one field may include bitfield ‘10’.

In some implementations, the MAC CE may include at least one field with one bitwidth to indicate the activation of the report configuration for the inter-frequency with a bit having the value 1 and indicate the deactivation of the report configuration for the inter-frequency with a bit having the value 0. For example, if a first report configuration associated with a first cell corresponds to a bit having the value 0, a second report configuration associated with a second cell corresponds to a bit having the value 0, a third report configuration associated with a third cell corresponds to a bit having the value 1, and a fourth report configuration associated with a fourth cell corresponds to a bit having the value 1, the UE may measure the third cell and the fourth cell based on the corresponding report configuration. In some implementations, the MAC CE may include at least one field with one bitwidth to indicate the activation of the report configuration for the inter-frequency with a bit having the value 0 and indicate the deactivation of the report configuration for the inter-frequency with a bit having the value 1.

In some implementations, the MAC CE may activate/deactivate the report configuration for the inter-frequency associated with a cell group, a PCI group, a BWP group, and/or a frequency group. In some implementations, the MAC CE may deactivate the report configuration for the inter-frequency associated with a cell group, a PCI group, a BWP group, and/or a frequency group. In some implementations, a MAC CE may activate/deactivate at least one measurement configuration and at least one report configuration for the inter-frequency when they are associated with each other. For example, if a report configuration is associated with a measurement configuration, the activation/deactivation signaling may apply to both the measurement configuration and report configuration.

In some implementations, the report configuration index may be included in the measurement configuration for the inter-frequency. In some implementations, the measurement configuration index may be included in the report configuration for the inter-frequency. In some implementations, a MAC CE may be used to trigger at least one inter-frequency report or measurement.

In some implementations, the triggering MAC CE may be used to activate/deactivate a semi-persistent measurement for the inter-frequency. More specifically, when the triggering MAC CE indicates an activation of a semi-persistent measurement, a UE may start a periodic measurement based on the measurement configuration for the inter-frequency. In some implementations, when the triggering MAC CE indicates a deactivation of a semi-persistent measurement, a UE may stop the periodic measurement based on the measurement configuration for the inter-frequency.

It should be noted that the UE may be configured with (or may receive the configuration of) the semi-persistent measurement for the inter-frequency via an RRC message from the source cell (or the serving cell).

In some implementations, the triggering MAC CE may be used to activate/deactivate a semi-persistent report configuration for the inter-frequency. More specifically, when the triggering MAC CE indicates an activation of a semi-persistent measurement configuration, a UE may start a periodic report based on the report configuration for the inter-frequency. In some implementations, when the triggering MAC CE indicates a deactivation of a semi-persistent report configuration, a UE may stop the periodic report based on the report configuration for the inter-frequency.

It should be noted that the UE may be configured with (or may receive the configuration of) the report configuration for the inter-frequency via an RRC message from the source cell (or the serving cell).

In some implementations, the DCI may include a field to request a report for the inter-frequency measurement. In some implementations, the 1-bit bitfield with the value 1 may indicate the triggering of an aperiodic report for the inter-frequency measurement and bitfield with value a value of 0 may indicate transmitting data without the aperiodic report for the inter-frequency measurement. In some implementations, the field may include a report configuration index for the inter-frequency measurement. In some implementation, the DCI with CRC scrambled by a specific CRC (e.g., RNTI for identifying LTM scheduling) may be used to request a report for the inter-frequency measurement. In some implementation, a specific DCI format (e.g., a format for identifying LTM scheduling) may be used to request a report for the inter-frequency measurement. In some implementations, the DCI transmitted on the LTM-specific search space (e.g., a search space configured to a UE in the RRC (pre-)configuration for LTM) may be used to request a report for the inter-frequency measurement. In some implementations, the DCI transmitted on the common search space/UE-specific search space may be used to request a report for the inter-frequency measurement.

In some implementations, a UE may report a UE capability to inform the BS whether to support the inter-frequency measurement. In some implementations, the UE may receive at least one measurement configuration for the inter-frequency measurement if the UE reports the support of the inter-frequency measurement. In some implementations, the UE may receive at least one measurement configuration for the intra-frequency measurement and inter-frequency measurement if the UE reports the support of the inter-frequency measurement. In some implementations, a UE may report a UE capability to inform the BS whether to support the inter-frequency report generation. In some implementations, the UE may receive at least one report configuration for the inter-frequency measurement if the UE reports the support of the inter-frequency report generation. In some implementations, the UE may receive at least one report configuration for the intra-frequency measurement and inter-frequency measurement if the UE reports the support of the inter-frequency report generation. In some implementations, the BS (e.g., the source cell, the serving cell) may request the UE to report its UE capability regarding whether the UE supports the inter-frequency measurement and report in LTM, via an RRC message (e.g., UECapabilityEnquiry message). In response to the reception of the RRC message (e.g., UECapabilityEnquiry message), the UE may report its UE capability regarding whether the UE supports the inter-frequency measurement and report in LTM, to the BS, via an RRC message (e.g., UECapabilityInformation message).

In some implementations, a report for the LTM may include SSB-based report quantities (e.g., L1-RSRP, L1-SINR, L1-RSRQ). In some implementations, a report for the LTM may include CSI-RS-based report quantities (e.g., L1-RSRP, L1-SINR, L1-RSRQ). In some implementations, a report for the LTM may include one or more PCIs (e.g., PCIs of the candidate cells, PCI of the source cell, PCI of the serving cell, or PCI of the target cell). In some implementations, the L1 measurement report may include one or more RS IDs. In some implementations, a report for the LTM may include a number of report quantities for the intra-frequency and a number of report quantities for the inter-frequency.

In some implementations, the order of the intra-frequency measurement result and inter-frequency measurement result in a single report may be such that the intra-frequency measurement result is prioritized before the inter-frequency measurement result. In some implementations, the intra-frequency measurement result may be based on an SSB-based measurement and the inter-frequency measurement result may be based on a CSI-RS-based measurement. In some implementations, the intra-frequency measurement result may be based on a CSI-RS-based measurement, and the inter-frequency measurement result may be based on an SSB-based measurement. In some implementations, the intra-frequency measurement result and inter-frequency measurement result may be both based on an SSB-based measurement. In some implementations, the intra-frequency measurement result and inter-frequency measurement result may be both based on a CSI-RS-based measurement. In some implementations, the order of the intra-frequency measurement result and inter-frequency measurement result in a single report may be such that the inter-frequency measurement result is prioritized before the intra-frequency measurement result.

In some implementations, a report may include a periodic report on a PUCCH and correspond to a periodic measurement configuration. In some implementations, a report may include a semi-persistent report on a PUCCH or a PUSCH and correspond to a periodic measurement configuration. In some implementations, a report may include a semi-persistent report on a PUCCH or a PUSCH and correspond to a semi-persistent measurement configuration. In some implementations, a report may include an aperiodic report on a PUSCH and correspond to a periodic measurement configuration. In some implementations, a report may include an aperiodic report on a PUSCH and correspond to a semi-persistent measurement configuration. In some implementations, a report may include an aperiodic report on a PUSCH and correspond to an aperiodic measurement configuration. In some implementations, the intra-frequency report and inter-frequency report may correspond to different report configurations but may be multiplexed into a single report if two reports are configured in the same resource.

In some implementations, if the intra-frequency report (transmitted on PUCCH, or transmitted on PUSCH) and inter-frequency report (transmitted on PUCCH, or transmitted on PUSCH) overlap in time and/or frequency, one of the intra-frequency report and inter-frequency report may be dropped/canceled. For example, the intra-frequency report may be regarded as high priority and the inter-frequency report may be dropped/cancelled. For example, the intra-frequency report may be regarded as low priority and the intra-frequency report may be dropped/cancelled.

In some implementations, the intra-frequency report may be dropped/canceled if the UL resource carrying the intra-frequency report overlaps a PUCCH repetition in time/frequency domain. In some implementations, the intra-frequency report may be dropped/canceled if the UL resource carrying the intra-frequency report overlaps a PUSCH repetition in time/frequency domain. In some implementations, the intra-frequency report may be dropped/canceled if the UL resource carrying the intra-frequency report overlaps a PUCCH carrying inter-frequency report in time/frequency domain. In some implementations, the intra-frequency report may be dropped/canceled if the UL resource carrying the intra-frequency report overlaps a PUSCH carrying the inter-frequency report in time/frequency domain.

In some implementations, the inter-frequency report may be dropped/canceled if the UL resource carrying the inter-frequency report overlaps a PUCCH repetition in time/frequency domain. In some implementations, the inter-frequency report may be dropped/canceled if the UL resource carrying the inter-frequency report overlaps a PUSCH repetition in time/frequency domain. In some implementations, the inter-frequency report may be dropped/canceled if the UL resource carrying the inter-frequency report overlaps a PUCCH carrying the intra-frequency report in time/frequency domain. In some implementations, the inter-frequency report may be dropped/canceled if the UL resource carrying the inter-frequency report overlaps a PUSCH carrying the intra-frequency report in time/frequency domain.

In some implementations, the UL resource carrying the intra-frequency report may correspond to a high priority (e.g., priority index=1) when the UL resource overlaps other UL resources. In some implementations, the UL resource with the intra-frequency report may correspond to a low priority (e.g., priority index=0) when the UL resource overlaps other UL resources. In some implementations, the UL resource with the inter-frequency report may correspond to a high priority (e.g., priority index=1) when the UL resource overlaps other UL resources. In some implementations, the UL resource with the inter-frequency report may correspond to a low priority (e.g., priority index=0) when the UL resource overlaps other UL resources.

In some implementations, the supported number of report quantities for the intra-frequency report and inter-frequency may be the same or different. In some implementations, the number of reports for the intra-frequency may be larger than the number of reports for the inter-frequency. In some implementations, the number of reports for the inter-frequency may be larger than the number of reports for the intra-frequency.

In some implementations, a UE may perform the RS measurement provided by the RRC message, MAC CE, and/or DCI to generate a measurement report for the LTM. In some implementations, a UE may report a UE capability to a BS to receive the corresponding signaling. In some implementations, a UE may receive an RRC message (e.g., RRC pre-configuration, RRC reconfiguration, RRC configuration), a MAC CE, and/or DCI including measurement information from a BS. In some implementations, a UE may receive an RRC message (or RRC signaling) for configuring measurement, reference signals, and/or report a configuration for the cell before performing the LTM or before performing cell switching, and the RRC message (or the RRC signaling) may not be used for (or not be dedicated to) the LTM. In some implementations, a UE may receive an RRC message (or RRC signaling) for configuring measurement, reference signals, and/or report configuration, and the RRC message (or the RRC signaling) may be different from an RRC message (or RRC signaling) dedicated to the LTM.

In some implementations, the received RRC message, MAC CE, and/or DCI may be used to indicate measurement configuration for the intra-frequency. In some implementations, the received RRC message, MAC CE, and/or DCI may be used to indicate a measurement configuration for the inter-frequency. In some implementations, the received RRC message, MAC CE, and/or DCI may be used to indicate a report configuration for the intra-frequency. In some implementations, the received RRC message, MAC CE, and/or DCI may be used to indicate a report configuration for the inter-frequency.

In some implementations, the UE may receive an RRC message, a MAC CE, and DCI in a predetermined order. In some implementations, the UE may receive an RRC message first and receive a MAC CE after receiving the RRC message. In some implementations, the UE may receive an RRC message first and receive DCI after receiving the RRC message. In some implementations, the UE may receive a MAC CE message first and receive DCI after receiving the RRC message. In some implementations, the UE may receive an RRC message first, receive a MAC CE after receiving the RRC message, and then receive DCI. In some implementations, the order may be determined based on the priority.

In some implementations, the UE may receive an RRC pre-configuration first and then receive an RRC configuration. In some implementations, a UE may receive an RRC message for the serving cell before an RRC message for at least one candidate cell. In some implementations, a UE may receive an RRC message for the serving cell and an RRC message for at least one candidate cell simultaneously. In some implementations, a UE may receive an RRC message for at least one candidate cell before receiving the cell switch command. In some implementations, a UE may receive an RRC message for at least one candidate cell after receiving the cell switch command. In some implementations, a UE may receive an RRC message for at least one candidate cell and the cell switch command simultaneously.

In some implementations, a UE may transmit a report for the intra-frequency measurement to the BS. In some implementations, a UE may transmit a report for the inter-frequency measurement to the BS. In some implementations, a UE may transmit a report for the intra-frequency measurement and inter-frequency measurement to the BS.

In some implementations, the BS may schedule a measurement signaling (or measurement configuration) provided by an RRC message, a MAC CE, and/or DCI to inform a UE to perform the measurement for the LTM. In some implementations, the BS may schedule a report signaling (or report configuration) provided by an RRC message, a MAC CE, and/or DCI to inform a UE to generate the report for the LTM. In some implementations, the BS may receive a UE capability from a UE to transmit corresponding signaling. In some implementations, a BS may transmit an RRC message (or an RRC signaling) for configuring measurement, reference signals, and/or report configuration for the cell before performing the LTM or before performing the cell switching, and the RRC message (or the RRC signaling) may not be used for (or not be dedicated to) the LTM. In some implementations, the BS may transmit an RRC message (or an RRC signaling) for configuring measurement, reference signals, and/or report configuration, and the RRC message (or the RRC signaling) may be different from an RRC message (or an RRC signaling) dedicated to the LTM.

In some implementations, the BS may transmit an RRC message (e.g., RRC pre-configuration, RRC reconfiguration, RRC configuration), a MAC CE, and/or DCI including measurement information to a UE. In some implementations, the transmitted RRC message, MAC CE, and/or DCI may be used to indicate measurement configuration for the intra-frequency. In some implementations, the transmitted RRC message, MAC CE, and/or DCI may be used to indicate measurement configuration for the inter-frequency. In some implementations, the transmitted RRC message, MAC CE, and/or DCI may be used to indicate report configuration for the intra-frequency. In some implementations, the transmitted RRC message, MAC CE, and/or DCI may be used to indicate report configuration for the inter-frequency.

In some implementations, the BS may transmit an RRC message, a MAC CE, and DCI in a predetermined order. In some implementations, the BS may transmit an RRC message first and transmit a MAC CE after transmitting the RRC message. In some implementations, the BS may transmit an RRC message first and transmit DCI after transmitting the RRC message. In some implementations, the BS may transmit a MAC CE message first and transmit DCI after transmitting the RRC message. In some implementations, the BS may transmit an RRC message first, transmit a MAC CE after transmitting the RRC message, and then transmit DCI. In some implementations, the order may be determined based on the priority.

In some implementations, the BS may transmit an RRC pre-configuration first and then transmit an RRC configuration. In some implementations, the BS may transmit an RRC message for the serving cell before an RRC message for at least one candidate cell. In some implementations, the BS may transmit an RRC message for the serving cell and an RRC message for at least one candidate cell simultaneously. In some implementations, the BS may transmit an RRC message for at least one candidate cell before transmitting the cell switch command. In some implementations, the BS may transmit an RRC message for at least one candidate cell after transmitting the cell switch command. In some implementations, the BS may transmit an RRC message for at least one candidate cell and the cell switch command simultaneously.

In some implementations, the BS may receive a report for the intra-frequency measurement from one or more UEs. In some implementations, the BS may receive a report for the inter-frequency measurement from one or more UEs. In some implementations, the BS may receive a report for the intra-frequency measurement and inter-frequency measurement from one or more UEs.

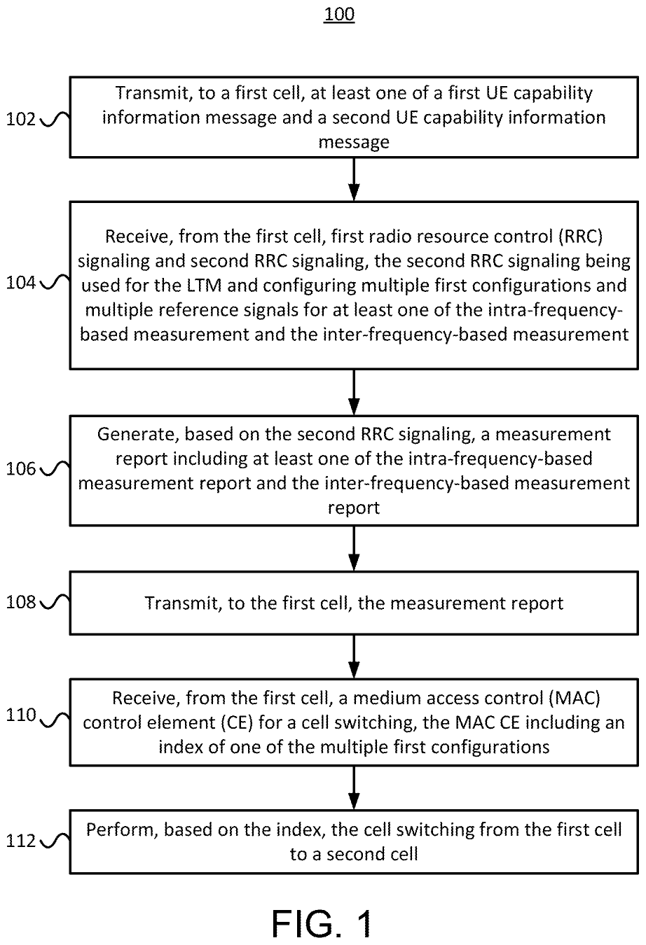

FIG. 1 is a flowchart 100 illustrating a method for managing LTM performed by a UE, according to an example implementation of the present disclosure.

In action 102, the UE may transmit, to a first cell, at least one of a first UE capability information message and a second UE capability information message. The first UE capability information message may indicate that the UE is capable of intra-frequency-based measurement and generating an intra-frequency-based measurement report, and the second UE capability information message may indicate that the UE is capable of inter-frequency-based measurement and generating an inter-frequency-based measurement report.

In action 104, the UE may receive, from the first cell, first radio resource control (RRC) signaling and second RRC signaling. The second RRC signaling may be used for the LTM and configure multiple first configurations and multiple reference signals for at least one of the intra-frequency-based measurement and the inter-frequency-based measurement. The second RRC signaling may be transmitted by the first cell based on the at least one of the first UE capability information message and the second UE capability information message.

In some implementations, the second RRC signaling may include an RRC reconfiguration message. In some implementations, the multiple reference signals may include synchronization signal blocks (SSBs) or channel state Information (CSI)-reference signals (RSs). In some implementations, the first RRC signaling may be used for configuring multiple second configurations and the multiple reference signals for the first cell. In some implementations, the multiple reference signals configured by the second RRC signaling may be the same as the multiple reference signals configured by the first RRC signaling. In some implementations, the multiple reference signals configured by the second RRC signaling may be different from the multiple reference signals configured by the first RRC signaling.

In action 106, the UE may generate, based on the second RRC signaling, a measurement report including at least one of the intra-frequency-based measurement report and the inter-frequency-based measurement report. In some implementations, the intra-frequency-based measurement report may include a measurement result of the intra-frequency-based measurement, and the inter-frequency-based measurement report may include a measurement result of the inter-frequency-based measurement.

In action 108, the UE may transmit, to the first cell, the measurement report.

In action 110, the UE may receive, from the first cell, a medium access control (MAC) control element (CE) for a cell switching. The MAC CE may include an index of one of the multiple first configurations.

In action 112, the UE may perform, based on the index, the cell switching from the first cell to a second cell.

In some implementations, each of the multiple first configurations may be associated with a physical cell identity (PCI) index, and the index may include a PCI index of the second cell. In some implementations, the first cell may be associated with a first base station, and the second cell may be associated with a second base station. In some implementations, the first cell and the second cell may be associated with a same base station.

In some implementations, in a case that both the first UE capability information message and the second UE capability information message are transmitted in action 102, the UE may transmit, to the first cell, a third UE capability information message and an indicator. The third UE capability information message may indicate that the UE is capable of generating both the intra-frequency-based measurement report and the inter-frequency-based measurement report in a single measurement report instance, the measurement report may include both a measurement result of the intra-frequency-based measurement and a measurement result of the inter-frequency-based measurement, and the indicator may indicate that a first part of the measurement report corresponds to the intra-frequency-based measurement report and a second part of the measurement report corresponds to the inter-frequency-based measurement report.

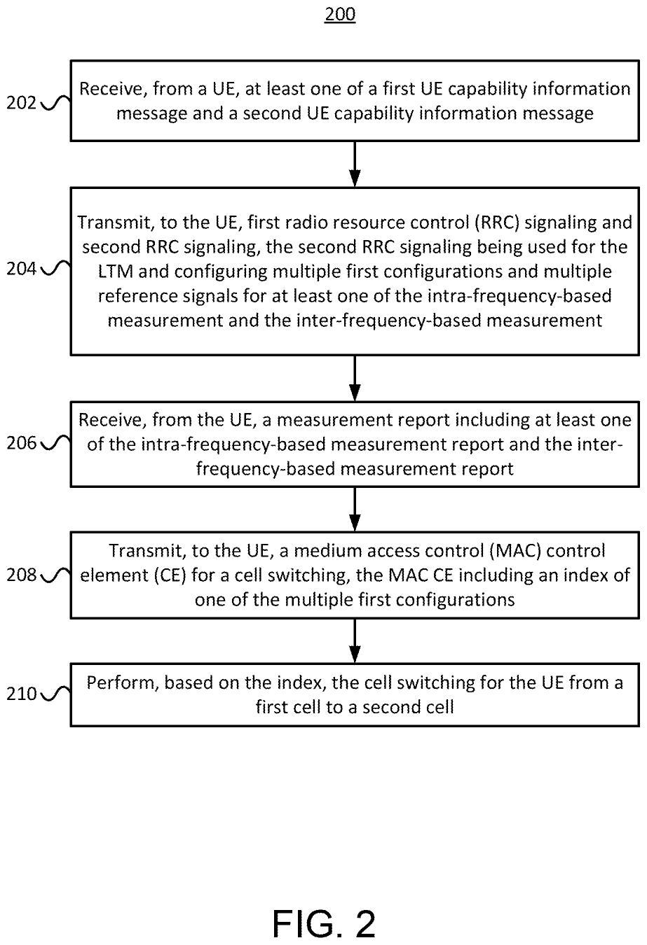

FIG. 2 is a flowchart 200 illustrating a method for managing LTM performed by a BS, according to an example implementation of the present disclosure.

In action 202, the BS may receive, from a UE, at least one of a first UE capability information message and a second UE capability information message. The first UE capability information message may indicate that the UE is capable of intra-frequency-based measurement and generating an intra-frequency-based measurement report, and the second UE capability information message may indicate that the UE is capable of inter-frequency-based measurement and generating an inter-frequency-based measurement report.

In action 204, the BS may transmit, to the UE, first radio resource control (RRC) signaling and second RRC signaling. The second RRC signaling may be used for the LTM and configure multiple first configurations and multiple reference signals for at least one of the intra-frequency-based measurement and the inter-frequency-based measurement. The second RRC signaling may be transmitted based on the at least one of the first UE capability information message and the second UE capability information message.

In some implementations, the second RRC signaling may include an RRC reconfiguration message. In some implementations, the multiple reference signals may include synchronization signal blocks (SSBs) or channel state Information (CSI)-reference signals (RSS). In some implementations, the first RRC signaling may be used for configuring multiple second configurations and the multiple reference signals for the first cell. In some implementations, the multiple reference signals configured by the second RRC signaling may be the same as the multiple reference signals configured by the first RRC signaling. In some implementations, the multiple reference signals configured by the second RRC signaling may be different from the multiple reference signals configured by the first RRC signaling.

In action 206, the BS may receive, from the UE, a measurement report including at least one of the intra-frequency-based measurement report and the inter-frequency-based measurement report. In some implementations, the intra-frequency-based measurement report may include a measurement result of the intra-frequency-based measurement, and the inter-frequency-based measurement report may include a measurement result of the inter-frequency-based measurement.

In action 208, the BS may transmit, to the UE, a medium access control (MAC) control element (CE) for a cell switching. The MAC CE may include an index of one of the multiple first configurations.

In action 210, the BS may perform, based on the index, the cell switching for the UE from a first cell to a second cell.

In some implementations, each of the multiple first configurations may be associated with a physical cell identity (PCI) index, and the index may include a PCI index of the second cell. In some implementations, the first cell may be associated with a first base station, and the second cell may be associated with a second base station. In some implementations, the first cell and the second cell may be associated with a same base station.

In some implementations, in a case that both the first UE capability information message and the second UE capability information message are received in action 202, the BS may receive, from the UE, a third UE capability information message and an indicator. The third UE capability information message may indicate that the UE is capable of generating both the intra-frequency-based measurement report and the inter-frequency-based measurement report in a single measurement report instance, the measurement report may include both a measurement result of the intra-frequency-based measurement and a measurement result of the inter-frequency-based measurement, and the indicator may indicate that a first part of the measurement report corresponds to the intra-frequency-based measurement report and a second part of the measurement report corresponds to the inter-frequency-based measurement report.

The technical problem addressed by the present disclosure is how to manage the UE's mobility between different cells, specifically focusing on LTM. This involves handling the complexities of switching cells without relying solely on higher-layer (Layer 3) signals, which may be less efficient in terms of latency and resource usage. Another aspect of the problem is the need for dynamic measurement and reporting based on intra-frequency and inter-frequency conditions. The UE needs to support and report measurements across different frequency ranges, which is critical for maintaining connection quality and service levels during mobility.

In the present disclosure, by enabling cell switching based on Layer 1/2 signals, the method may potentially reduce the latency associated with cell switching, leading to a more responsive and efficient mobility process. The method provided on the present disclosure allows the UE to adapt its measurement and reporting capabilities based on the frequency characteristics (intra-frequency or inter-frequency), which is advantageous in dynamically changing network environments. This flexibility ensures that the UE may maintain optimal performance and connectivity.

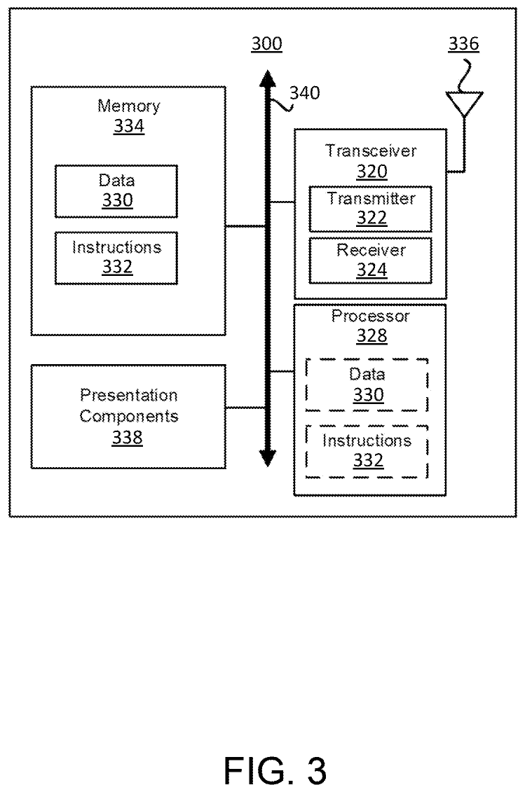

FIG. 3 is a block diagram illustrating a node 300 for wireless communication in accordance with various aspects of the present disclosure. As illustrated in FIG. 3, a node 300 may include a transceiver 320, a processor 328, a memory 334, one or more presentation components 338, and at least one antenna 336. The node 300 may also include a radio frequency (RF) spectrum band module, a BS communications module, a network communications module, and a system communications management module, Input/Output (I/O) ports, I/O components, and a power supply (not illustrated in FIG. 3).

Each of the components may directly or indirectly communicate with each other over one or more buses 340. The node 300 may be a UE or a BS that performs various functions disclosed with reference to FIGS. 1 and 2.

The transceiver 320 has a transmitter 322 (e.g., transmitting/transmission circuitry) and a receiver 324 (e.g., receiving/reception circuitry) and may be configured to transmit and/or receive time and/or frequency resource partitioning information. The transceiver 320 may be configured to transmit in different types of subframes and slots including, but not limited to, usable, non-usable, and flexibly usable subframes and slot formats. The transceiver 320 may be configured to receive data and control channels.

The node 300 may include a variety of computer-readable media. Computer-readable media may be any available media that may be accessed by the node 300 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules, or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules, or other data in a modulated data signal, such as a carrier wave, or other transport mechanisms and include any information delivery media.

The term “modulated data signal” may mean a signal that has one or more of its characteristics set or changed in such a manner as to encode information in the signal. Communication media may include wired media, such as a wired network or direct-wired connection, and wireless media, such as acoustic, RF, infrared, and other wireless media. Combinations of any of the previously listed components should also be included within the scope of computer-readable media.

The memory 334 may include computer-storage media in the form of volatile and/or non-volatile memory. The memory 334 may be removable, non-removable, or a combination thereof. Example memory may include solid-state memory, hard drives, optical-disc drives, etc. As illustrated in FIG. 3, the memory 334 may store a computer-readable and/or computer-executable instructions 332 (e.g., software codes) that are configured to, when executed, cause the processor 328 to perform various functions disclosed herein, for example, with reference to FIGS. 1 and 2. Alternatively, the instructions 332 may not be directly executable by the processor 328 but may be configured to cause the node 300 (e.g., when compiled and executed) to perform various functions disclosed herein.

The processor 328 (e.g., having processing circuitry) may include an intelligent hardware device, e.g., a Central Processing Unit (CPU), a microcontroller, an ASIC, etc. The processor 328 may include memory. The processor 328 may process the data 330 and the instructions 332 received from the memory 334, and information transmitted and received via the transceiver 320, the baseband communications module, and/or the network communications module. The processor 328 may also process information to send to the transceiver 320 for transmission via the antenna 336 to the network communications module for transmission to a CN.

One or more presentation components 338 may present data indications to a person or another device. Examples of presentation components 338 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a user equipment (UE) for managing layer 1 (L1)/layer 2 (L2)-triggered mobility (LTM), the method comprising:
transmitting, to a first cell, at least one of a first UE capability information message and a second UE capability information message, the first UE capability information message indicating that the UE is capable of intra-frequency-based measurement and generating an intra-frequency-based measurement report, and the second UE capability information message indicating that the UE is capable of inter-frequency-based measurement and generating an inter-frequency-based measurement report;
receiving, from the first cell, first radio resource control (RRC) signaling and second RRC signaling, the second RRC signaling being used for the LTM and configuring a plurality of first configurations and a plurality of reference signals for at least one of the intra-frequency-based measurement and the inter-frequency-based measurement, the second RRC signaling being transmitted by the first cell based on the at least one of the first UE capability information message and the second UE capability information message;
generating, based on the second RRC signaling, a measurement report comprising at least one of the intra-frequency-based measurement report and the inter-frequency-based measurement report;
transmitting, to the first cell, the measurement report;
receiving, from the first cell, a medium access control (MAC) control element (CE) for a cell switching, the MAC CE comprising an index of one of the plurality of first configurations; and
performing, based on the index, the cell switching from the first cell to a second cell.

2. The method of claim 1, wherein the second RRC signaling comprises an RRC reconfiguration message.

3. The method of claim 1, wherein the plurality of reference signals comprises synchronization signal blocks (SSBs) or channel state Information (CSI)-reference signals (RSS).

4. The method of claim 1, wherein:
each of the plurality of first configurations is associated with a physical cell identity (PCI) index, and
the index comprises a PCI index of the second cell.

5. The method of claim 1, wherein the first RRC signaling is used for configuring a plurality of second configurations and the plurality of reference signals for the first cell.

6. The method of claim 1, wherein:
the intra-frequency-based measurement report comprises a measurement result of the intra-frequency-based measurement, and
the inter-frequency-based measurement report comprises a measurement result of the inter-frequency-based measurement.

7. The method of claim 1, further comprising:
in a case that both the first UE capability information message and the second UE capability information message are transmitted transmitting, to the first cell, a third UE capability information message and an indicator, wherein:
the third UE capability information message indicates that the UE is capable of generating both the intra-frequency-based measurement report and the inter-frequency-based measurement report in a single measurement report instance,
the measurement report comprises both a measurement result of the intra-frequency-based measurement and a measurement result of the inter-frequency-based measurement, and
the indicator indicates that a first part of the measurement report corresponds to the intra-frequency-based measurement report and a second part of the measurement report corresponds to the inter-frequency-based measurement report.

8. The method of claim 1, wherein:
the first cell is associated with a first base station, and
the second cell is associated with a second base station.

9. The method of claim 1, wherein the first cell and the second cell are associated with a same base station.

10. A user equipment (UE) for managing layer 1 (L1)/layer 2 (L2)-triggered mobility (LTM), the UE comprising:
one or more processors; and
at least one memory coupled to at least one of the one or more processors, the at least one memory storing computer-executable instructions that, when executed by the at least one of the one or more processors, cause the UE to:
transmit, to a first cell, at least one of a first UE capability information message and a second UE capability information message, the first UE capability information message indicating that the UE is capable of intra-frequency-based measurement and generating an intra-frequency-based measurement report, and the second UE capability information message indicating that the UE is capable of inter-frequency-based measurement and generating an inter-frequency-based measurement report;
receive, from the first cell, first radio resource control (RRC) signaling and second RRC signaling, the second RRC signaling being used for the LTM and configuring a plurality of first configurations and a plurality of reference signals for at least one of the intra-frequency-based measurement and the inter-frequency-based measurement, the second RRC signaling being transmitted by the first cell based on the at least one of the first UE capability information message and the second UE capability information message;
generate, based on the second RRC signaling, a measurement report comprising at least one of the intra-frequency-based measurement report and the inter-frequency-based measurement report;
transmit, to the first cell, the measurement report;
receive, from the first cell, a medium access control (MAC) control element (CE) for a cell switching, the MAC CE comprising an index of one of the plurality of first configurations; and
perform, based on the index, the cell switching from the first cell to a second cell.

11. The UE of claim 10, wherein the second RRC signaling comprises an RRC reconfiguration message.

12. The UE of claim 10, wherein the plurality of reference signals comprises synchronization signal blocks (SSBs) or channel state Information (CSI)-reference signals (RSs).

13. The UE of claim 10, wherein:
each of the plurality of first configurations is associated with a physical cell identity (PCI) index, and
the index comprises a PCI index of the second cell.

14. The UE of claim 10, wherein the first RRC signaling is used for configuring a plurality of second configurations and the plurality of reference signals for the first cell.

15. The UE of claim 10, wherein:
the intra-frequency-based measurement report comprises a measurement result of the intra-frequency-based measurement, and
the inter-frequency-based measurement report comprises a measurement result of the inter-frequency-based measurement.

16. The UE of claim 10, wherein the computer-executable instructions, when executed by the at least one of the one or more processors, further cause the UE to:
transmit, to the first cell, a third UE capability information message and an indicator, wherein:
the third UE capability information message indicates that the UE is capable of generating both the intra-frequency-based measurement report and the inter-frequency-based measurement report in a single measurement report instance,
the measurement report comprises both a measurement result of the intra-frequency-based measurement and a measurement result of the inter-frequency-based measurement, and
the indicator indicates that a first part of the measurement report corresponds to the intra-frequency-based measurement report and a second part of the measurement report corresponds to the inter-frequency-based measurement report.

17. The UE of claim 10, wherein:
the first cell is associated with a first base station, and
the second cell is associated with a second base station.

18. The UE of claim 10, wherein the first cell and the second cell are associated with a same base station.

19. A base station (BS) for managing layer 1 (L1)/layer 2 (L2)-triggered mobility (LTM), the BS comprising:
one or more processors; and
at least one memory coupled to at least one of the one or more processors, the at least one memory storing computer-executable instructions that, when executed by the at least one of the one or more processors, cause the BS to:
receive, from a user equipment (UE), at least one of a first UE capability information message and a second UE capability information message, the first UE capability information message indicating that the UE is capable of intra-frequency-based measurement and generating an intra-frequency-based measurement report, and the second UE capability information message indicating that the UE is capable of inter-frequency-based measurement and generating an inter-frequency-based measurement report;
transmit, to the UE, first radio resource control (RRC) signaling and second RRC signaling, the second RRC signaling being used for the LTM and configuring a plurality of first configurations and a plurality of reference signals for at least one of the intra-frequency-based measurement and the inter-frequency-based measurement, the second RRC signaling being transmitted based on the at least one of the first UE capability information message and the second UE capability information message;
receive, from the UE, a measurement report comprising at least one of the intra-frequency-based measurement report and the inter-frequency-based measurement report;
transmit, to the UE, a medium access control (MAC) control element (CE) for a cell switching, the MAC CE comprising an index of one of the plurality of first configurations; and
perform, based on the index, the cell switching for the UE from a first cell to a second cell.

20. The BS of claim 19, wherein the first RRC signaling is used for configuring a plurality of second configurations and the plurality of reference signals for the first cell.
